(19) United States
(12) Patent Application Publication
(10) Pub. No.: US 2019/0251199 A1
(43) Pub. Date: Aug. 15, 2019

(54) Transactions Across Blockchain Networks

(71) Applicant: Ivan Klianev, Brighton-Le-Sands (AU)

(72) Inventor: Ivan Klianev, Brighton-Le-Sands (AU)

(21) Appl. No.: 15/896,085

(22) Filed: Feb. 14, 2018

(51) Int. Cl. G06F 17/30; G06F 11/16; G06F 11/14; G06Q 40/02; G06Q 40/04

(52) U.S. Cl. CPC G06F 17/30584; G06F 17/30371; G06F 17/30377; G06Q 40/04; G06F 11/1662; G06F 11/1438; G06Q 40/02; G06F 17/30348

(57) ABSTRACT

In asynchronous public network, synchronous leaderless Byzantine consensus protocol operating with guaranteed safety and time-bound termination of individual protocol rounds is enabled with nodes having clustered architecture and highly available data transactions, and implemented with algorithm that defuses the effect of stop-faulty processes and bypasses the partitioned network links. Utilizing the time-bound consensus, a protocol and architecture for cross-chain transactions accomplish safe interoperability across blockchain networks. Multiple cross-chain transacting networks interconnected in a federation overcome the limitations of blockchain networks with monolithic ledgers in regard to transaction latency, scalability of throughput, volume of managed data, and openness for further interoperability.

### CROSS-REFERENCE TO RELATED APPLICATIONS

Not Applicable

### BACKGROUND OF THE INVENTION

### Field of the Invention

This invention is about: 1) time-bound deterministic consensus over the Internet for state machine replication across multiple active replicas of a decentralized database; 2) transactions across decentralized databases; 3) global interoperability across a plurality of regional sets of interconnected decentralized databases for transfer and exchange of tokenized value.

### Description of the Previous Art

The Internet made communicating and sharing information a widely accessible privilege. As a tool for distribution of data, it served the purpose of informational democracy in an extremely efficient manner. Efficiency, however, was not a characteristic of using the Internet for business involving transfer of digital assets, such as money in bank account. Sending data is in fact sending a copy of it, not the original. As a significant consequence of that, a number of intermediaries are needed to perform multiple roles just to ensure that sending a digital asset is not a sending of its copy.

Since the effective end of the Bretton Woods system¹ of monetary management in August 1971 and the following move to fiat-based currency², the vast majority of money in the world are nothing more than an entry in a ledger. It is made by central banks when they create reserves and by commercial banks when they extend credit. It lives in digital ledgers inside databases spread through the financial system. Therefore, the fiat money³ is nothing more than a promise and movement of funds is simply an adjustment of databases to reflect the changes in promises. ¹ https://en.wikipedia.org/wiki/Bretton_Woods_system² https://en.wiktionary.org/wiki/fiat_currency#English³ https://en.wikipedia.org/wiki/Fiat_money

Two-phase-commit⁴ protocol is a distributed algorithm that coordinates the database management systems⁵ participating in a distributed atomic transaction⁶ on whether to commit⁷ or roll back⁸. The protocol is a perfect fit for double entry accounting transactions involving two separate database systems, but it is not resilient to all possible failures and thus cannot provide guaranteed reconciliation. It assumes that: participating nodes do not experience stop-faults or Byzantine⁹ faults, data in the write-ahead log¹⁰ is never lost or corrupted, and nodes can freely communicate with each other. Therefore, when one of those assumptions turned out incorrect, a human intervention may be needed to remedy the consequences resulting from the failure. ⁴ https://en.wikipedia.org/wiki/Two-phase_commit_protocol⁵ https://en.wikipedia.org/wiki/Database⁶ https://en.wikipedia.org/wiki/Distributed_transaction⁷ https://en.wikipedia.org/wiki/Commit_(data_management)⁸ https://en.wikipedia.org/wiki/Rollback_(data_management)⁹ https://en.wikipedia.org/wiki/Byzantine_fault_tolerance¹⁰ https://en.wikipedia.org/wiki/Write-ahead_logging

Execution of distributed double entry accounting transactions between two database systems with Two-phase-commit protocol over the Internet became a reality since its commercial use started. A Transaction-Internet¹¹ protocol was designed to make the Two-phase-commit protocol more secure when used over the Internet by combining it with Secure Socket Layer¹² (Transport Layer Security¹³) for public key encryption and authentication. Making it more secure, however, does not solve its inherent safety¹⁴ and liveness¹⁵ issues accelerated by the fact that in the Internet environment transaction participants cannot be expected to always cooperate. ¹¹ https://www.w3.org/2001/03/WSWS-popa/paper01¹² https://en.wikipedia.org/wiki/SSL¹³ https://en.wikipedia.org/wiki/Transport_Layer_Security¹⁴ https://en.wikipedia.org/wiki/Safety_(distributed_computing)¹⁵ https://en.wikipedia.org/wiki/Liveness

To illustrate a possible safety issue with Two-phase-commit protocol, a stop-faulty node during the commit phase of the protocol leaves the system in inconsistent state. For example, a paying node reduces the content of the payer account but a stop-faulty payee node fails to increase the content of the payee account. Alternatively, a payee node increases the content of the payee account but a stop-faulty or a Byzantine-faulty paying node fails to reduce the content of the payer account. Prevention of flooding the financial system with non-existing money requires complex reconciliation procedures.

To illustrate a possible liveness issue, a lost connection or a stop-faulty node may prevent terminating a transaction coordinated with Two-phase-commit protocol, or a transaction manager could fake failure with an objective to block other transaction managers. It would be difficult for the blocked participants to differentiate between genuine and fake failures. These participants typically hold locks on resources of the involved accounts while being blocked, thereby placing the account owners in a state of commercial disadvantage.

Bitcoin¹⁶ blockchain¹⁷ technology is an alternative to globally distributed transactions coordinated with a two-phase-commit. The blockchain achieves consistency¹⁸ in the system with locally executed but globally replicated transactions and guarantees atomic consistency (linearizability¹⁹) between all replicas with a mechanism employing the self interest of participants. As a by product, it provides a degree of immutability²⁰ of records resulting from the committed transactions and does not require a human intervention, administration, or reconciliation. Bank of England described the technology as a first attempt at an ‘Internet of finance’²¹ as it operates in an entirely decentralized way, without intermediaries such as banks. Deutsche Bank sees the blockchain technologies as a solution capable to guard against risks associated with IT systems failure²². ¹⁶ https://en.wikipedia.org/wiki/Bitcoin¹⁷ https://en.wikipedia.org/wiki/Blockchain_(database)¹⁸ https://en.wikipedia.org/wiki/Consistency_(database_systems)¹⁹ https://en.wikipedia.org/wiki/Linearizability²⁰ https://en.wikipedia.org/wiki/Immutable_object²¹ https://bankofengland.co.uk/publications/Documents/quarterlybulletin/2014/qb14q3digitalcurrenciesbitcoin1.pdf²² https://www.db.com/newsroom_news/Deutsche_Bank_Investor_Report.pdf

Money in a blockchain is like cash, but with significant improvements²³. Blockchain-based currencies cannot be counterfeited and can be easily traced. Blockchains function by being records of the movements of each coin from the moment it is created. Since the record is public, it is easy to ensure that each coin is only assigned to one account. Yet, these qualities were facilitated by the Bitcoin blockchain with a questionable engineering achievement. It eliminates the cheap talk²⁴ and circumvents CAP theorem²⁵, but burns electricity like a small nation²⁶ using proof-of-work protocol²⁷ just to provide utility with a capacity much below the needs of that nation. ²³ Building the Trust Engine. UBS Group Technology White Paper 2016²⁴ https://en.wikipedia.org/wiki/Cheap_talk²⁵ https://en.wikipedia.org/wiki/CAP_theorem²⁶ https://karlodwyergithub.io/publications/pdf/bitcoin_KJOD_2014.pdf²⁷ https://en.wikipedia.org/wiki/Proof-of-work_system

A blockchain is a single monolithic ledger for all accounts of all its users, maintained by all replica nodes. It could be a proper design choice for a ledger with small number of accounts or infrequent use; otherwise, it is hardly effective or efficient. The global replication requires messaging across all continents, even for a transfer of $5 between two adjacent towns. Synchronization of multiple copies of the ledgers incurs significant costs even when all copies can be trusted as accurate and their operations are honest. The costs arise much higher when the participants cannot trust each other and thereby making the social costs prohibitively high.

Blockchains operate using state machine replication²⁸. Every replica must execute the transaction requests received on all replicas under an agreed common sequential order. State machine²⁹ is an abstract device that executes a command and produces an outcome. Starting from the same initial state, state machines executing the same command finish with the same final state. In the same manner, replicas starting from atomically consistent³⁰ state and executing the same sequence of transactions finish with atomically consistent state. Agreement about the common sequential order is essential for efficient replication, especially over the Internet. ²⁸ https://en.wikipedia.org/wiki/State_machine_replication²⁹ https://en.wikipedia.org/wiki/Finite-state_machine³⁰ https://en.wikipedia.org/wiki/Consistency_model

Where a network partition splits a distributed system, the CAP theorem states that if the system needs to be available to continue processing requests it has to give up the atomic consistency of replicas since there is no way to achieve an agreement about a common sequential order of execution of all transaction requests received on all replicas. Alternatively, if the system needs to preserve the atomic consistency, it has to give up the availability and stop the processing of requests. Bitcoin in effect circumvents the CAP theorem. It doesn't really care about network partitions as long as the whole world is not split in two parts that cannot communicate between themselves, which is practically impossible with the multiple alternative routs of the Internet.

In a system where anyone can freely enroll, a simple vote is not enough for an agreement since the communication between participants constitutes a cheap talk: 1) the cost to construct and delivery a message is effectively zero. 2) messages are not binding as the participants can drop out and later freely reenroll. 3) the validity of a transaction is not fully verifiable without access to all copies of the ledger. To addresses the cheap talk problem, Bitcoin stipulates that to gain the right to propose an addition to the ledger any participant must prove that it has done costly work.

Instead of aiming for an impossible agreement, Bitcoin motivates the participants to compete against each other for the so called mining money³¹ by performing CPU-intensive computations in searching for a cryptographic proof of work³² and requires each participant to accept the sequential order of a group of requests received by the participant that was first to solve the proof of work. The sequential order on the winning computer becomes binding order for all other participants. The burnt energy and the limited transactional throughput are price for the eliminated cheap talk and for the achieved common sequential order. ³¹ https://www.genesis-mining.com/³² https://en.bitcoin.it/wiki/Proof_of_work

The proof of work system allows a participant to prove the paid cost without a need to disclose identity. This allows cryptocurrencies to maintain a completely decentralized network with free entry and exit of participants but decreases the ledger's total throughput capacity. In its first version, Bitcoin was limited to between 7 and 10 transactions per second and it takes an hour before a transaction can be trusted. This is the price to run a decentralized database with availability, atomically consistent replicas on the majority of open membership computers, and tolerance to coordinated malicious attempts of less than half of members.

Reducing the latency of Bitcoin network operations may happen with reducing the interval between blocks, while increasing the throughput may be achieved with increasing the block size³³. These would give advantage to large mining pool over small miners and lead to centralization, which offsets the decentralization as Bitcoin's founding principle and makes the network vulnerable to adversary attacks. ³³ https://allquantor.at/blockchainbib/pdf/eyal2016bitcoinng.pdf

In contrast to blockchain networks operating with proof of work consensus, networks that promise to operate with hash-graph consensus^{34 35 36} try to utilize the concept of directed acyclic graph³⁷. This is a promising direction for further research and development, yet it is not clear whether the concept can be implemented in a decentralized network with industrial strength. For example, the hash-graph consensus relies on signed messages between nodes, but there is no way a node in an open network to know in advance every other node's public key and to verify that a node sending a signed message is in fact the node it claims it is. Eventual use of services of a certificate authority would make safety of performance depend on a single point of failure. ³⁴ http://www.swirlds.com/downloads/SWIRLDS-TR-2016-01.pdf³⁵ https://byteball.org/Byteball.pdf³⁶ https://iota.org/IOTA_Whitepaper.pdf³⁷ https://en.wikipedia.org/wiki/Directed_acyclicgraph

State machine replication needs a deterministic database³⁸ operations. Bitcoin utilizes Google's open source NoSQL data engine LevelDB³⁹, which doesn't have a transaction manager, but being a permissionless blockchain Bitcoin does not really need one. The low throughput makes the sequential execution of requests an affordable luxury, which makes any database perform deterministically. This is paid with some increase of latency, but with no decline of throughput. ³⁸ http://www.slideshare.net/abadid/the-power-of-determinism-in-database-systems³⁹ http://leveldb.org/

Digital currencies aspiring for long-term success based on higher social impact need more efficient agreement solutions. Efficiency requires giving up the proof of work, which enforces giving up the permissionless networks. Ripple⁴⁰ and Stellar⁴¹ exemplify notable endeavors to accomplish an efficient in terms of throughput agreement solution with a permissioned network, which does not restrict the number of participants. Both Ripple and Stellar, however, emulate the Bitcoin blockchain approach of using a ledger with monolithic central state. Guaranteeing safety, unrestricted growth, and decentralization are mutually exclusive objectives where a ledger with monolithic central state is used. ⁴⁰ https://en.wikipedia.org/wiki/Ripple_(company)⁴¹ https://en.wikipedia.org/wiki/Stellar_(payment_network)

In the future, essential utility will be the ability to transfer funds with email speed across a billion of frequently used accounts around the globe. Interoperability across digital ledgers is a necessary element of a solution, but not the solution. Safety of an interoperability-based solution depends on liveness of involved ledgers and the weakest link may destroy it. Alternatively, a single monolithic ledger requires a huge amount of messages to propagate the requests and synchronize the outcome and ability to sustain the critical speed of data operations inside a node with expanding volumes of data, thus making unfeasible the essential balance of throughput and latency.

In addition to the amount of messages required to keep the replicas in sync, a monolithic ledger with global replication demands the use of a complex consensus protocol. This is inefficient The more complex the synchronization with asynchronous messaging, the more expensive it is in terms of time. Moreover, this approach is unsustainable. Bitcoin illustrates operations with monolithic ledgers. For the last 12 months, the size of its blockchain increased⁴² from 90 GB to 140 GB and its long term growth curve⁴³ has a hyper-linear shape. Ledger size of a system with thousand times higher throughput will easily grow up to a petabyte and its data operations will need scaling out with horizontal partitioning just to cope with the workload. ⁴² https://blockchain.info/charts/blocks-size⁴³ https://blockchain.info/charts/blocks-size?timespan=all

At present, multi-partition database transactions degrade the throughput and defeat the reason to scale out. In addition, no transaction management product currently on the market can guarantee high availability of multi-partition transactions. A blocked transaction may prevent participation in the voting rounds of a stateful consensus protocol and the subsequent update of state. Achieving the needed throughput and latency like most credit cards is unfeasible with a single ledger having a monolithic state and global replication. Such throughput, eventually achievable with consensus rounds that involve very large sets of transactions, will have prohibitively large latencies as a complex consensus with asynchronous messages cannot become more efficient and the speed of data transmission cannot exceed the speed of light. Understanding the limits imposed by the consensus protocol requires a brief description of differences: a) between stateful communication protocols and stateless communication protocols; and b) between stateful consensus protocols and stateless consensus protocols;

A stateless communication protocol⁴⁴ is one that treats each request as independent and unrelated to any previous request, so that the communication consists of independent pairs of request and response. A stateful communication protocol is one that needs to keep the internal state, which is outcome from previous sessions, as it affects the outcome of next sessions. A session of any consensus protocol comprises multiple communication rounds with a stateful communication protocol. The stateful communication within a consensus protocol is unavoidable. The outcome of a round is affected by the outcome of previous rounds of a consensus session. ⁴⁴ https://en.wikipedia.org/wiki/Statelessprotocol

A stateless consensus protocol is one where the outcome of a protocol session is completely independent from the outcome of all previous sessions. A stateful consensus protocol is one where the outcome of a session is causally dependent from the outcome of previous sessions.

In the context of payment networks, the objective of consensus is to prevent double spending. One way of accomplishing this is to sequentially order all requested transactions. A consensus about the sequential order guarantees that in case of an attempted double spending all replicas will successfully complete exactly the same transaction as first one and reject the second one.

The second way to prevent double spending is slightly more complex. Once transaction requests are received on a node, all of them are executed against the node's replica of the ledger. In a case of an attempted double spending, the first one will be completed and the second one will be rejected. The outcome is not made durable before the consensus protocol achieves its objective. What causes a problem is the fact that requests arrive to different nodes in different order. Nothing guarantees that the resulting pairs of “one completed, one rejected” transactions are the same on all nodes, and therefore on all replicas of the ledger. The protocol aims an agreement about which one of both transaction to complete. Typically it requires multiple voting rounds.

Protocols aiming consensus about the ordering of requests are stateless. Sequential ordering of a bunch of requests is in no way related to the sequential ordering of any previous bunch. The protocols must guarantee that even the tolerated number of malicious nodes will know the agreed sequential order per each session. This is a strict safety guarantee, not a probabilistic one. The strictness of safety has its price. Every node must be aware of every other node participating in a protocol session and these protocols are clearly inapplicable with permissionless networks. Additionally, the number of the necessary per session messages is exponentially related to the number of nodes and the performance becomes inefficient with large permissioned networks.

Protocols that involve voting rounds are stateful. Detection of a double spending depends on state, which is result of previous consensus sessions. Thus, the safety of a stateful consensus protocol is strictly dependent on the atomic consistency between the state on all nodes. Otherwise, one node may detect an attempted double spending but another one may not. Protocols' safety guarantees are probabilistic. Strict guarantees are impractical—too many voting rounds take too much time and would destroy protocols' utility. On the positive side, the nodes do not need to be aware of every other node in a protocol session. Properly structured propagation of requests and voting can enable unrestricted expansion of number of network nodes. Stateful consensus is the price for unrestricted number of nodes in a ledger. Maintaining safety with a probabilistic guarantee requires maintaining a delicate and vulnerable equilibrium between the possible consequences of events beyond control. A negligible miscalculation of probabilities combined with unpredictable sequence of events may negatively affect it.

Blockchains' monolithic central state and the stateful consensus protocols are inconvenient for the future Internet-of-Value, which is better to be built⁴⁵ with stateless consensus protocols in the way the Internet was built with stateless communication protocols. It requires safety, performance, unrestricted growth, and decentralization, but the unrestricted growth using a ledger with monolithic central state dictates the use of a stateful consensus protocol. The balance between performance and probabilistically guaranteed safety dictates the need of a central administration to configure the propagation of requests and voting. Therefore, safety with the required performance and unrestricted growth cannot coexist with decentralization. Thus, the monolithic central state precludes some of the critically important properties of the Internet-of-Value. ⁴⁵ https://medium.com/@justmoon/the-subtle-tyranny-of-blockchain-91d98b8a3a65#.c4574d9vf

It will need high number of frequently used accounts, high throughput, low latency, safety, liveness, unrestricted growth, and decentralization. These cannot be achieved with a permissionless ledger with monolithic state, or with a permissioned ledger with monolithic state and a stateful consensus protocol, or with a permissioned ledger with monolithic state and a stateless consensus protocol.

A not yet explored way of satisfying all of the above requirements is to device a composite ledger, which operates as federation of permissioned ledgers each with a monolithic state, where each ledger uses a stateless consensus protocol. With such federation, safety of transactions that modify the state of two monolithic ledgers depends on liveness of the participating ledgers as well. Safety of transactions of a composite ledger, however, does not depend on health of a single node or two nodes where two monolithic ledgers intersect. Thus, a stop-faulty or Byzantine faulty node cannot affect the safety of transactions with distributed state.

Agreement within a reasonable time frame inside a permissioned blockchain system is a feasible objective where the number of participants is limited and their identities are known in advance. A permissioned blockchain system with a restricted number of replicas can provide a built-in tolerance to a proportional number of malicious replicas, eliminate the waste of energy, and radically increase the throughput. A thousand transactions per second and few seconds latency even with replicas on different continents and tens of thousands of transactions with short distances between replicas are realistic objectives.

Execution of an asynchronous agreement protocol is the most vulnerable step in replication. Completion of this step with no risks for liveness or throughput is as important as the safety. It requires elimination of the possibility that during its execution the agreement protocol can lock and stay locked until expiring of a timeout interval. At present, however, no known technology can guarantee this without spoiling the safety or atomic consistency of replicas. Some of the brightest computer scientists devoted years to the theory and practice of replication via asynchronous network with distributed agreement. Despite these, not all issues of interdependence between safety, liveness, and throughput are fully solved.

Where a network link uses routers, no bound can be placed on the time it takes to deliver a message. Packet's delay on a router depends on how full router's queuing buffer is in packet's direction. Moreover, when the buffer overflows, the router has no other choice but to drop the packet. Similarly, a process on a healthy computer may take different time to perform a request, mainly because a different number of queued requests may wait for execution. Queuing lets cope with spikes of incoming requests. A system where no bound is placed on time to process a request or to deliver a message is qualified as asynchronous one. In contrast, synchronous system is one where performing a request or delivering a message that takes too long is considered a failure.

The necessity of a time bound is an unavoidable evil with the asynchronous systems at present. Castro-Liskov⁴⁶ and Byzantine Paxos⁴⁷ asynchronous agreement protocols cannot guarantee simultaneous safety and liveness in event of a stop-faulty or malicious computer, or a partitioned network. As Leslie Lamport⁴⁸ wrote⁴⁹, in theory these protocols tolerate faulty computers, but in practice have difficulty distinguishing a faulty computer from an ordinary delayed message. The same is true with computers maliciously delaying a reply message to block the protocol. ⁴⁶ http://pmg.csail.mit.edu/papers/osdi99.pdf⁴⁷ http://research.microsoft.com/en-us/um/people/lamport/tla/byzsimple.pdf⁴⁸ https://en.wikipedia.org/wiki/Leslie_Lamport⁴⁹ Leaderless Byzantine Consensus, U.S. Pat. No. 7,797,457

Castro-Liskov algorithm, for example, relies on synchrony for liveness. This lets an attacker who controls the protocol leader to slow down the system performance. Even without a single Byzantine-faulty node in the system, a network partition that creates a minority group with more than a third of all nodes will block the entire system since the consensus algorithm cannot terminate. Alternatively, when the algorithm operates with the maximum tolerated Byzantine-faulty nodes, a single lost message will prevent algorithm termination and the system will block.

The FLP result is a short way to refer to the theorem⁵⁰ of Fischer, Lynch, and Paterson. It proves that a system cannot guarantee agreement with one faulty node in an asynchronous network by showing that a possible blocking of the agreement protocol cannot be ruled out. Use of a time bound prevents blocking. Processing requests while a faulty or malicious replica is being recovered, however, spoils the atomic consistency between the recovered replica and the rest. Moreover, during a delayed message or network partition, a replica may be seen as stop-faulty or malicious and excluded from the protocol. This prevents locking but spoils the throughput and may impair the ability to neutralize a real malicious behavior, thus damaging the consistency. ⁵⁰ https://groups.csail.mit.edu/tds/papers/Lynch/jacm85.pdf

For a permissioned blockchain that aims to perform with high throughput, the sequential execution is not an option. It needs a transaction manager—to increase the throughput with a serializable⁵¹ execution order, which ensures a serial effect with concurrent execution. Moreover, it needs the transaction manager to be deterministic—to ensure execution with exactly the same serializable order on every replica. Multiple database systems provide deterministic transaction management. The unsolved problem with each one of these systems is the scalability of managed data. A blockchain database is append-only and immutable. Nothing is ever deleted. With a thousand transactions per second, the volume of data grows rapidly and beyond a certain point starts degrading the performance. ⁵¹ https://en.wikipedia.org/wiki/Serializability

Normal response is to scale out with partitioning of data. It works well where the nature of data allows perfect partitioning. This means a transaction does not, and will never have to, access more than one partition. Blockchain use cases rarely permit perfect partitioning. Accessing multiple partitions requires distributed transactions⁵², which are prone to blocking⁵³, thus negatively affecting the availability, and have high performance costs⁵⁴, thus defeating the reason to scale out. Scaling out is inevitable with the ever expanding data. Devising highly available high-throughput distributed transactions is a problem waiting its solution. ⁵² https://en.wikipedia.org/wiki/Distributed_transaction⁵³ https://en.wikipedia.org/wiki/Two-phase_commit_protoco⁵⁴ http://adrianmarriott.net/logosroot/papers/LifeBeyondTxns.pdf

The following non-existing technologies are necessary and sufficient where the goal is to guarantee safety, liveness, and throughput in an asynchronous public network, and availability, atomic consistency and throughput with a scaled out database:

1. Circumvention of CAP theorem for permissioned networks. It needs invention of a messaging scheme with multiple communication paths and guaranteed delivery. This is sufficient to prevent a partitioned wide area network link from evolving into partitioned distributed system.

2. Circumvention of FLP result. It needs a replica node to be a cluster with reliable operations, which sends the expected replies regardless of a stop-faulty process or computer. This, together with a guaranteed message delivery, is sufficient to prevent blocking of any asynchronous agreement protocol.

3. New type of database transactions. They need to be highly available deterministic multi-partition transactions, which are capable to access multiple partitions with no degrading the throughput or latency. This is sufficient to scale out the data operations without risking the throughput and availability.

4. Asynchronous leaderless Byzantine consensus algorithm. This is sufficient to preclude the possibility of attacks on liveness of the agreement when a Byzantine-faulty node becomes a leader.

A permissioned blockchain, built with reliance on these technologies and having a limited number of participating nodes, can achieve its goals. It would have the best of Bitcoin: perform with guaranteed consistency and availability, provide tolerances to network partitions and malicious attempts, and run on decentralized infrastructure with decentralized administration. It would be better than Bitcoin: run with no use of excessive computing power and electric energy, and perform with high throughput, low latency, and scalability of data.

Circumvention of the FLP result would increase the tolerance to Byzantine faults of some stateless consensus protocols from (n−1)/3 to the theoretical maximum of (n−1)/2, where n is the number of ledger nodes. The increased tolerance to Byzantine faults is extremely important for any stateless consensus protocols as scaling the number of nodes compromises the protocol efficiency.

Having digital currencies operating with no single point of failure, however, does not mean that a user can purchase an amount denominated in a particular digital currency paying with amount denominated in another digital currency or fiat money, or sell an amount denominated in a particular digital currency for an amount denominated in another digital currency or fiat money, with no reliance on a system with a single point of failure. While digital currency networks seem protected from hacking, the digital currency exchanges are not⁵⁵. ⁵⁵ http://cryptorials.io/5-biggest-bitcoin-exchange-hacks/

“Cryptocurrencies need decentralized exchanges . . . One in sixteen bitcoins have been stolen.”⁵⁶ It is not e technical challenge to built a decentralized exchange using a permissioned blockchain technology. The challenge is to facilitate transactional interoperability between such an exchange and the networks of traded digital currencies. ⁵⁶ https://news.bitcoin.com/blocknet-centralized-exchanges/

Internet was born out of the routers-facilitated forwarding of messages between local networks. Similarly to the way routers guarantee that a piece of data transmitted with TCP/IP will not be lost despite the possibility of transmitted packets being lost, transactional interoperability between blockchain networks should guarantee that a digital token will not be lost or duplicated in the process if its transmission from an account on the ledger of one blockchain network to an account on the ledger of another blockchain network

Pegged sidechains^{57 58} is a technology, which enables digitally represented value to be transferred between multiple blockchains. This technology, however, does not accomplish direct interoperability between blockchains. The owner of a digital asset has to immobilize it in the source (parent) blockchain and then send a message to the destination blockchain (sidechain) with a proof of immobilization and a request for creation on the sidechain the equivalent of the immobilized digital asset. ⁵⁷ https://blockstream.com/sidechains.pdf⁵⁸ https://gendal.me/2014/10/26/a-simple-explanation-of-bitcoin-sidechains/

The pegged sidechains technology may compromise safety of the parent blockchain. Origin of the main safety issue is the fact that the parent blockchain knows nothing about safety of the sidechain where the owner of an asset may decide to transfer it, but has to accept a proof from that sidechain on the way back of that asset. Thus, a user with malicious intentions may execute a theft by creating a worthless sidechain and move a valuable asset to it. The safety issue arises when the asset is being returned back to the parent blockchain. The parent blockchain has to accept the inbound proof based on its formal correctness only.

An attempt to accomplish direct interoperability between blockchains without moving digital tokens between blockchain networks is the protocol for Interledger Payments⁵⁹. It alms to enable secure transfer of value from an account in one blockchain to an account in another blockchain by using services provided by an entity with accounts on both blockchains. Assuming a fixed exchange rate between digital tokens used in each blockchain, as a result of the service provided to one transfer of value, the content of entity's account in the sender's blockchain will increase with the sent amount of digital tokens, while the content of entity's account in the recipient's blockchain will decrease with an amount of digital tokens that is equivalent to the value of the sent amount of digital tokens. ⁵⁹ https://interledger.org/interledger.pdf

The protocol for Interledger Payments operates in two modes: Universal and Atomic. The Atomic mode uses services of a notary blockchain to coordinate an interledger transaction similarly to the way Two-Phase Commit protocol use Transaction Coordinator. Safety of an Atomic mode interledger transaction may be compromised if the consensus protocol of the notary blockchain halts and its liveness is lost. Moreover, in both modes, safety of interledger payments depends on liveness of participating blockchains. To illustrate this with a simple interledger payments involving two blockchains, if liveness of one of the blockchains does not hold for whatever reason, this may affect the safety of the ledger of the other blockchain as a consequence of the non-atomic execution and result in one of the ledger accounts ending with incorrect amount of contained assets. Thus, an entirely healthy blockchain may end up with a ledger with compromised safety as a result of the compromised liveness of another blockchain.

Project Cosmos⁶⁰ of Tendermint⁶¹ is an attempt to accomplish direct interoperability between blockchains that enables transfer of digital value between blockchain networks. Tendermint consensus⁶² protocol uses proof-of-stake⁶³ algorithm, implemented with a Byzantine Fault Tolerant consensus similar to the mentioned Castro-Liskov algorithm, to replace the energy inefficient proof-of-work. ⁶⁰ https://cosmos.network/whitepaper⁶¹ https://tendermint.com/intro⁶² https://tendermint.com/static/docs/tendermint.pdf⁶³ https://en.wikipedia.org/wiki/Proof-of-stake

Cosmos implements a hierarchical architecture where a central blockchain called Cosmos Hub lets other blockchains called zones connect to it. A zone can transfer tokens to another zone through Cosmos Hub, which keeps record of the total number of tokens in each connected zone. From the publicly available information, Cosmos network employs the same principle as with pegged sidechains—tokens must be immobilized in one blockchain and created in the other blockchain. Unlike with sidechains, however, the process is automated but nothing has been published at the time of writing about how the transfer involving three blockchains—sender zone, Cosmos Hub, and recipient zone—is implemented and what are its safety assumptions.

Cosmos Hub uses Tendermint consensus. Designers of Cosmos stated that Tendermint consensus favors consistency over availability. Translated from database designers' language to system designers' language this means that Tendermint consensus favors safety over liveness and during network partition the consensus algorithm may halt. Involvement of Cosmos Hub in a cross-chain transaction with no guarantees for Cosmos Hub liveness is equally endangering transaction safety as would the lack of guarantees for Cosmos Hub safety—tokens may be immobilized in one blockchain without being created in the other blockchain.

No known technology at present can implement cross-chain transactions with guaranteed safety regardless of anything that possibly may go wrong within the tolerated limit per each blockchain that participates in a cross-chain transaction. A successful implementation of such transactions depends on ability to implement a Byzantine consensus protocol with algorithm that operates with guaranteed both safety and liveness. According to the knowledge created by computer science and accumulated in practice, this is impossible.

### BRIEF SUMMARY OF THE INVENTION

This invention makes it feasible to build a deterministic consensus network with a time-bound termination of consensus protocol rounds over asynchronous communication network such as the Internet. The time-bound termination of the protocol rounds is ensured with a synchronous leaderless Byzantine consensus protocol, which is implemented by algorithm that capitalizes on an architecture of consensus network nodes, each implemented as a cluster of computers with high-availability of operations and data transactions, to defuse the effect of stop-faulty processes and to bypass the partitioned network links. Further, the invention devises transactions that transfer units of a crypto token across interconnected blockchain networks that operate with time-bound deterministic consensus. Finally, the invention uses the cross-blockchain transactions to design a federation of interconnected blockchain networks and to enact interoperability between a multitude of such federations for transfer and exchange of tokenized value.

### BRIEF DESCRIPTION OF THE DRAWINGS

FIG. 1 is simplified block diagram of a consensus network system of three nodes interconnected over the Internet.

FIG. 2 is block diagram of a consensus network system of three nodes interconnected over the Internet using an Internet service provider per node.

FIG. 3 is block diagram of a consensus network system of three nodes interconnected over the Internet using two Internet service providers per node to establish two connections between any two nodes.

FIG. 4 is block diagram of a consensus network system of three nodes interconnected over the Internet using two Internet service providers per node to establish two connections that share routers between any two nodes.

FIG. 5 is block diagram of a consensus network system of three nodes interconnected over the Internet using two Internet service providers per node and each node is implemented as a cluster with highly available consensus messaging operations.

FIG. 6 is flowchart of detection, neutralization, and recovery of a stop-faulty process on a computer of a cluster of two computers.

FIG. 7 is block diagram of a blockchain node built as a cluster of computers with resilient operations ensured with redundant communication paths and replicated functional elements.

FIG. 8 is block diagram of a consensus network system of five nodes implemented over the Internet and ensuring time-bound delivery of messages despite the existence of a network partition and two Byzantine nodes.

FIG. 9 is flowchart of an algorithm for execution of phase One of a synchronous leaderless Byzantine consensus protocol in asynchronous communication environment.

FIG. 10 is flowchart of an algorithm for execution of phase Two of a synchronous leaderless Byzantine consensus protocol in asynchronous communication environment.

FIG. 11 is block diagram of ledgers of two interconnected blockchain networks and the first of two intra-ledger transactions that implement cross-chain transfer of units of a crypto token.

FIG. 12 is block diagram of ledgers of two interconnected blockchain networks and the messages that relate both intra-ledger transactions of a cross-blockchain transfer of units of a crypto token.

FIG. 13 is block diagram of ledgers of two interconnected blockchain networks and the second of two intra-ledger transactions that implement cross-chain transfer of units of a crypto token.

FIG. 14 is block diagram of the ledger of a blockchain network, an escrow account and the two possible outcomes of an escrow contract that controls the escrowed content.

FIG. 15 is block diagram of ledgers of two interconnected blockchain networks and step One of a direct cross-chain transaction transferring units of a crypto token from any account to any account.

FIG. 16 is block diagram of ledgers of two interconnected blockchain networks and step Two of a direct cross-chain transaction transferring units of a crypto token from any account to any account.

FIG. 17 is block diagram of ledgers of two interconnected blockchain networks and step Three of a direct cross-chain transaction transferring units of a crypto token from any account to any account.

FIG. 18 is block diagram of ledgers of two interconnected blockchain networks and step Four of a direct cross-chain transaction transferring units of a crypto token from any account to any account.

FIG. 19 is block diagram of ledgers of two interconnected blockchain networks and step Five of a direct cross-chain transaction transferring units of a crypto token from any account to any account.

FIG. 20 is block diagram of ledgers of two interconnected blockchain networks and final state of a direct cross-chain transaction transferring units of a crypto token from any account to any account.

FIG. 21 is block diagram of a federation of eight interconnected blockchain networks, where every network is directly interconnected to every other network.

FIG. 22 is block diagram of three connected for interoperability federations, each comprising eight interconnected blockchain networks.

FIG. 23 is block diagram of sub-transaction One of the simplest indirect cross-chain transaction.

FIG. 24 is block diagram of sub-transaction Two of the simplest indirect cross-chain transaction.

FIG. 25 is block diagram of sub-transaction Three of the simplest indirect cross-chain transaction.

FIG. 26 is block diagram of sub-transaction Four of the simplest indirect cross-chain transaction.

FIG. 27 is block diagram of sub-transaction Five of the simplest indirect cross-chain transaction.

FIG. 28 is block diagram of sub-transaction Six of the simplest indirect cross-chain transaction.

FIG. 29 is block diagram of sub-transaction Seven of the simplest indirect cross-chain transaction.

FIG. 30 is block diagram of sub-transaction Eight of the simplest indirect cross-chain transaction.

FIG. 31 is block diagram of sub-transaction Nine of the simplest indirect cross-chain transaction.

FIG. 32 is block diagram of the final state of the simplest indirect cross-chain transaction.

### DETAILED DESCRIPTION OF THE INVENTION

Intrinsic value of blockchain networks is the ability to transfer units of crypto tokens over the Internet with no need of a trusted third party and the ability to trade units of one crypto token for units of another with settlement happening as part of the trade. Safety of these operations is guaranteed with transactions.

Most significant performance characteristic of a blockchain network is its throughput measured with the maximum transactions the network can perform per second. The throughput is affected by the type of used consensus protocol and by physical parameters of the network, such as the number of network nodes and the largest physical distance between any two nodes.

The following tradeoffs have to be taken in consideration when designing a blockchain network. A network with nearly unlimited number of nodes but very low throughput can be built with a probabilistic consensus protocol. In contrast, a network with restricted for efficiency number of nodes but much higher throughput can be built with a deterministic consensus protocol.

Networks operating with a probabilistic consensus are typically open networks that everyone is welcome to join and contribute to decentralization, whose most important aspect is the proportion of network nodes under control of a single entity. This turned to be a self delusion as any entity aspiring control is free to join with as many nodes as it can sustain. To illustrate with an example, at the time of writing 78% of Bitcoin nodes are under control of 6 entities, one of these entities controls nearly 20%, and three of them control more than 51%. Thus, any deterministic network that tolerates 3 colluding nodes is more decentralized than Bitcoin.

Networks operating with a deterministic consensus are not free for everyone to join. As a result, one entity operates one node and the level of decentralization is proportional to the number of nodes in the network. Large decentralization of a network with deterministic consensus causes lower throughput as every node has to exchange message with every other node of the network. For example, a PBFT network of 7 nodes needs less than 100 messages to be exchanged for a consensus, while a PBFT network of 13 nodes needs more than 300 messages for a consensus.

On the other end of the spectrum, every change that a probabilistic network implements to increase its throughput tends to further diminish the decentralization by placing the large pools of nodes, each under control of a single entity, in a privileged position letting further minimize the chances of vast majority of entities operating a node, or a small pool of controlled nodes, to play a role in the consensus.

Regardless of the consensus protocol type, larger distance between network nodes always causes lower throughput. To illustrate with examples of the possible extremes, nodes of a blockchain network that might be designed to run a stock exchange should be connected with a local area network for highest possible throughput, while the nodes of a Bitcoin network are dispersed around the world and its throughput is very low.

Therefore, if the objective of a blockchain networks is to be reasonably decentralized and with high throughput, it should be a permissioned one with carefully selected node operators and with close physical proximity of nodes. Such network could have handled the needs of the entire world with high throughput and reasonably low latency but only for a while. A blockchain network operates with an append only database on each nodes. The volume of data in the database of each node of the network will soon explode beyond the manageable limit and the throughput will collapse.

Each blockchain network maintains a database with monolithic state replicated on each nodes. The world does not need just one database to serve its needs. Only the parties that frequently interact with each other, or at least with a real chance of a need to interact with each other, have to be on the same network and be served by a single database.

Having a larger database with a monolithic state serving the whole world might be beneficial in some use cases. For example, a blockchain aiming to be a global marketplace of crypto-tokens may benefit from the network effect of having as many users as possible since every user is a potential trading party to any other user. In contrast, a blockchain offering services as a payment network will reflect the purchasing of physical goods and consumption of services that typically happen locally. Even the largest global online retail network, Amazon, already has multiple regional centers, each serving a specific geographic area.

The ideal in regard to efficiency of operations hypothetical global blockchain payment network should have the following structure. It will consist of multiple permissioned blockchain networks each serving a particular economic area or a national state or a group of smaller national states. One set of these blockchain networks will be interconnected for interoperability into a regional federation of blockchain networks to handle cross-chain payments. For example, only a small proportion of all payments in the EU goes across national borders. As a result of such structuring, the dominant proportion of payments will happen in the most efficient way as intra-chain transactions and only a small part will be performed in the less efficient way as cross-chain transactions. Finally, a federation of blockchain networks serving a particular global region will be connected for interoperability with all other existing regional federations around the globe.

Bitcoin network was the first to demonstrate that a distributed system using the Internet as a medium for communication can perform with both consistency and availability. According to CAP theorem this should have been impossible. Bitcoin achieved that with a probabilistic consensus. No blockchain network, however, has so far demonstrated performance with both consistency and availability using a deterministic consensus. All known networks with a deterministic consensus have to favor safety over liveness, which means consistency over availability. The inability to guarantee both is what prevents devising transactions that transfer crypto-tokens across blockchain networks.

Lack of an ability to devise transactions across blockchain networks prevents devising a global payment network in the most efficient way—building it up as interoperating regional federations of interoperating blockchain networks. This way designed, a global payment network will operate in the most efficient way in the following aspects. In regard to consumption of electricity—a deterministic consensus does not operate with a proof-of-work. In regard to throughput—a network with deterministic consensus and limited number of nodes with close proximity to each other operates with high throughput, and the higher is the number of such networks operating in parallel the higher is the total throughput. In regard to data management—the only way to handle the volume of data accumulated while serving the global payment needs is to partition these data among multiple operating in parallel blockchain networks.

This invention enables building up permissioned blockchain networks that use a deterministic consensus and guarantee both consistency and availability of their operations, where the invariant for availability is a time-bound completion of every round of the used deterministic consensus protocol. Having these done, a pair of such blockchain networks may interconnect for interoperability, and devise and perform transactions that transfer crypto-tokens across their ledgers. A federation can be built by interconnecting every member network to every other member network.

Two federations can interconnect by having two member networks of the one interconnect for cross-chain transactions with two member networks of the other federation. If both federations use the same crypto-token for intra-federation cross-chain transactions the interoperability will be straightforward. Otherwise, at least one of the four blockchain networks that enact the interoperability across the two federations will have to provide a facility to exchange units of the crypto-token used in one of the federations for units of the crypto-token used in the other one of the federations.

The rest of the description provides detailed explanation how to accomplish: 1) Time-bound delivery of messages over the Internet; 2) Detection, neutralization, and recovery of a faulty process; 3) High-availability of network node and its data transactions; 4) A consensus network that is tolerant to faulty processes and partitioned network links; 5) Transactions for transfer of crypto-tokens across interconnected blockchain networks; 6) A federation of interconnected blockchain networks; 7) Interoperability across multiple federations serving as a backbone of the future Internet-of-value.

Packet switching public networks operate asynchronously. Packet received by a router are buffered in queues for desired direction. A spike of packets from multiple input directions for the same output direction may use the forwarding capacity up to its limit. To avoid its buffer overflown, a router has no other option but to start dropping the arrived packets. This causes retransmission of the packets handled with transmission control protocol (TCP), possibly multiple times. During such periods, network links that utilize a congested router are seen as partitioned. A certain number of datagram packets is inevitably lost, while packets with TCP-controlled forwarding are delayed. The chance of such delays and their variable extent in time make it impossible to ensure time-bound exchange of messages.

Distributed systems need to deal with partitioned network links. Consistency, availability, and partition tolerance (CAP) theorem⁶⁴ proves that during a network partition a distributed system may continue serving clients requests but cannot guarantee consistency of operations or should stop serving clients requests if consistency is critically important. The theorem proof uses a two-server hypothetical system that receives requests on both servers and maintains atomic consistency of data replicas even when a request processing involves data modification. The proof demonstrates that if both servers continue processing requests during a network partition, the atomic consistency of data replicas on each server cannot be guaranteed. The proof is correct with any two-server configuration where a network partition inevitably causes partition of the system. Where two network links connect the two servers, a network link partition does not cause a system partition. Thus, it seems that circumvention of CAP theorem requires just two network links that use no common router. Yet, with public networks satisfying such requirement is difficult to guarantee. ⁶⁴ Seth Gilbert and Nancy Lynch, “Brewer's conjecture and the feasibility of consistent, available, partition tolerant web services”. SigAct News, June 2002

An algorithm⁶⁵ operating with an asynchronous network shows that in the face of network partitions and process failure it can guarantee that with a connected majority of nodes each message is delivered within at most two communication rounds, if no failures occur during these rounds. The algorithm propagated the messages using a gossip mechanism. ⁶⁵ I. Keidar and D. Dolev. “Totally ordered broadcast in the face of network partitions.” Dependable Network Computing, pages 51-75, D. Avresky Editor, Kluwer Academic Publication. January, 2000

In some types of network, gossiping is not the most efficient way to bypass network partitions as it will flood the network with unnecessary messages. In absence of network partitions, another approach is more efficient. Where all nodes know each other, the max time needed for a message from every node to be delivered to every other node can be estimated in advance. If a node does not receive an expected message within the expected time, the node can broadcast a request for the missing message. In reply, the nodes that have already received both the message and the request for it, will respond with sending the missing message to the requestor. This approach combines the best of both worlds. In absence of network partitions, the distributed system will operate in the most efficient manner. In detection of condition that might indicate existence of a partitioned network link, the system switches itself temporarily from the most efficient to the most effective manner of operation.

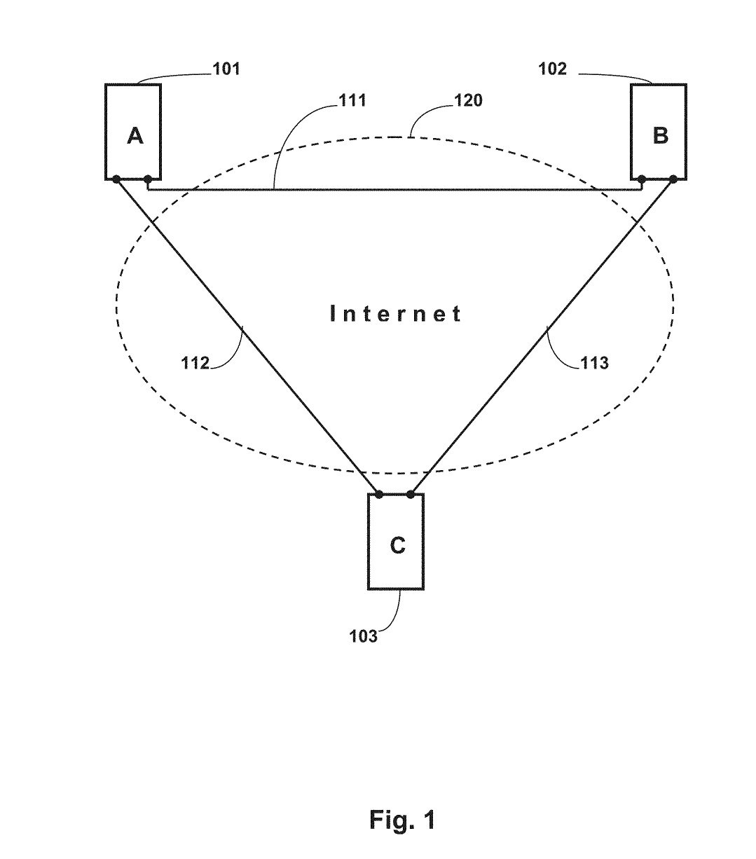

FIG. 1 is simplified block diagram of a consensus network system of three nodes 101, 102, and 103 interconnected with connections 111, 112, and 113 established over the Internet 120. A consensus protocol typically require each node to multicast its message to every other node. Say, the network link 111 between nodes 101 and 102 is partitioned in both directions. As a result, the message multicast by node 103 is received by both nodes 101 and 102, but the messages multicast by nodes 101 and 102 are received by node 103 only. Nodes 101 and 102 may request the missing messages from node 103 and thus in effect bypass the partitioned network link.

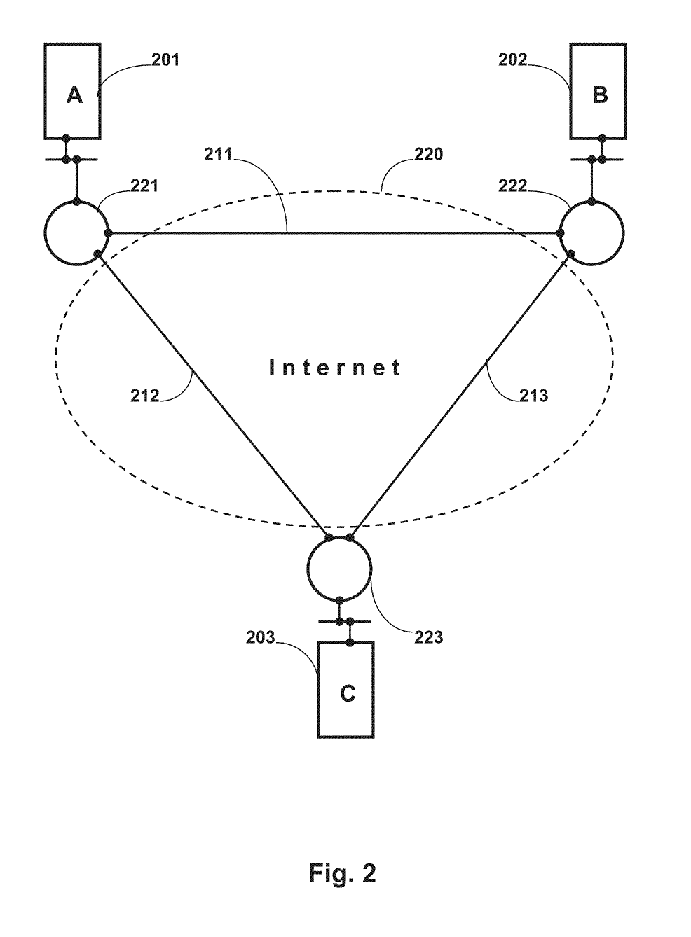

FIG. 2 is block diagram of a consensus network system of three nodes interconnected over the Internet using an Internet service provider per node. It is a more realistic presentation of the shown on FIG. 1 consensus network. Each one of the three nodes 201, 202, and 203 of the network access the Internet 220 via an internet service provider (ISP) presented as 221, 222, and 223. A faulty ISP, however, will totally cut off a node from the rest of network and in effect is equivalent to partition of all network links to that node. Where a system aiming reliability has no control over the behavior of one of its elements, the best approach is to replicate it.

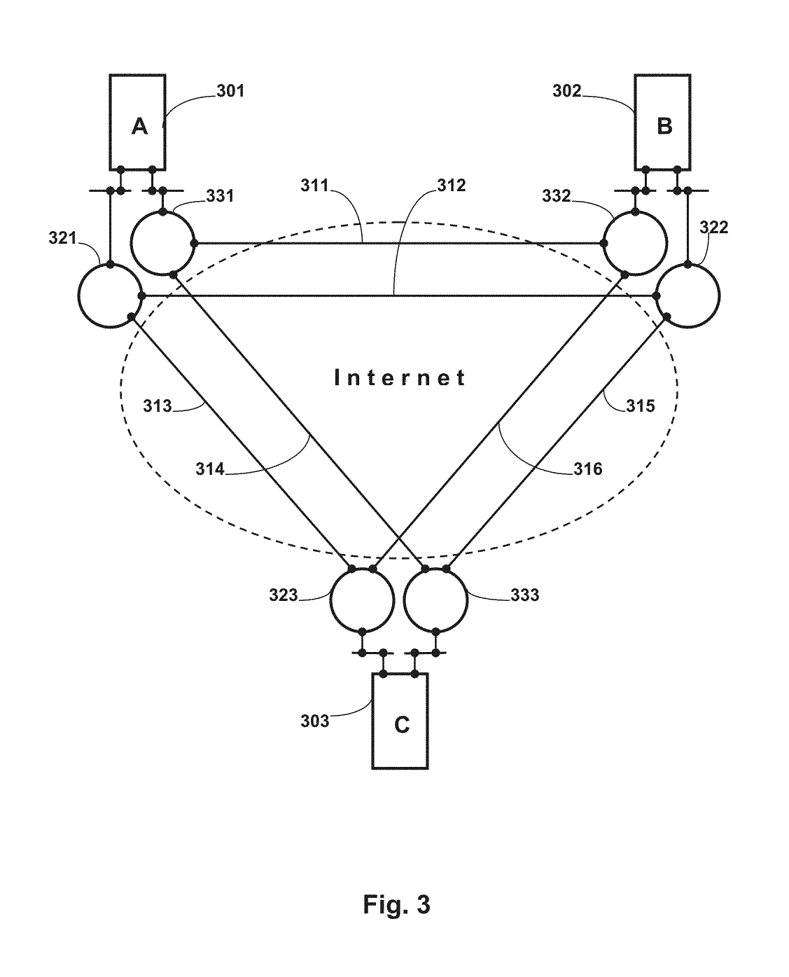

FIG. 3 is block diagram of a consensus network system of three nodes interconnected over the Internet using two Internet service providers per node to establish two connections between any two nodes. Every node establishes two connections to every other node. Each connection uses a different ISP to access the Internet and a different ISP used by the connected node to access the Internet. Node 301 connects to the Internet via ISPs 321 and 331. Node 302 connects to the Internet via ISPs 322 and 332. Node 303 connects to the Internet via ISPs 323 and 333. Node 301 establishes two connections to node 302 via ISP 321, link 312, and ISP 322 and via ISP 331, link 311, and ISP 332. Node 302 establishes two connections to node 301 via ISP 322, link 311, and ISP 321 and via ISP 332, link 312, and ISP 331. Node 301 establishes two connections to node 303 via ISP 321, link 313, and ISP 323 and via ISP 331, link 314, and ISP 333. Node 303 establishes two connections to node 301 via ISP 323, link 313, and ISP 321 and via ISP 333, link 314, and ISP 321. Node 302 establishes two connections to node 303 via ISP 322, link 315, and ISP 333 and via ISP 332, link 316, and ISP 323. Node 303 establishes two connections to node 301 via ISP 333, link 315, and ISP 322 and via ISP 323, link 316, and ISP 332.

The existence of two connections from a node to any other node may create an impression that the partition problems are solved. Such impression might be a correct representation of the reality as long as both connections do not share a router. Yet sharing a router cannot be excluded as possibility. The most common reason causing two connections from a node to another node to use network links with a common router is to utilize the shortest way between the two nodes. Where the shortest way goes through a common communication line, the routers on both ends of that line are common for both connections and a congested router delays messages transmitted over both connections.

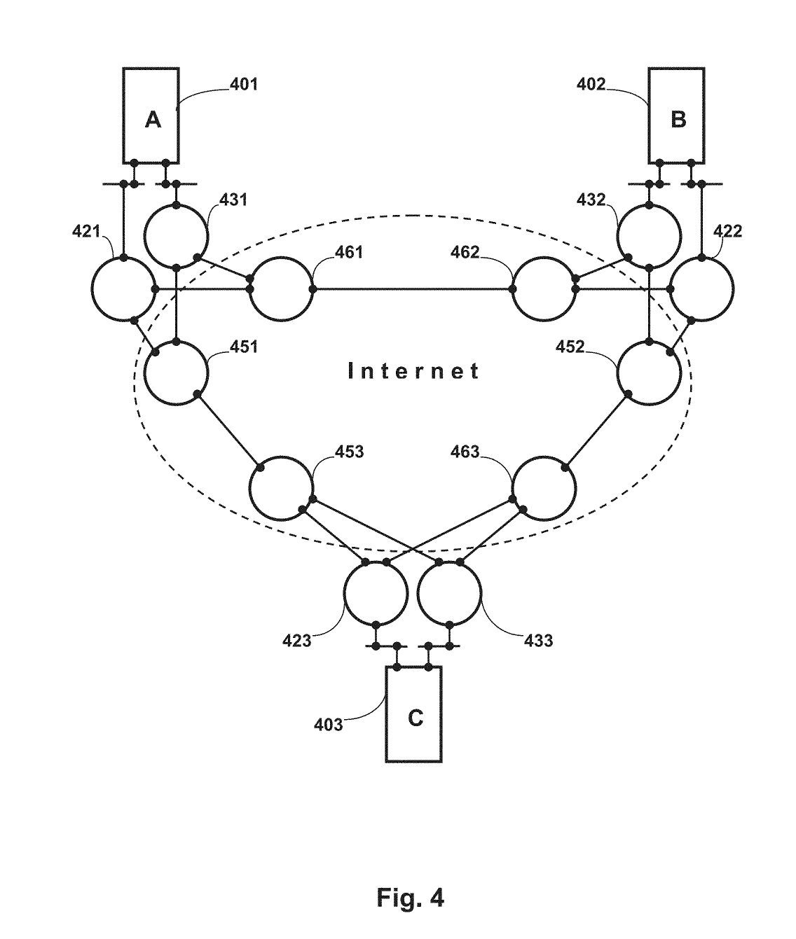

FIG. 4 shows a realistic configuration of network links that the inter-node connections of FIG. 3 may have to use. With this configuration, congestion of anyone of the routers within the dotted ellipse—451, 452, 453, 461, 462, and 462—will create a network partition between two nodes. However, as long as at least one ISPs of the ISP pairs per node—ISP 421 and ISP 431 of node 401, ISP 422 and ISP 432 of node 402, and ISP 423 and ISP 433 of node 403—operates with no congestion, no node will be cutoff from the rest of the network. Therefore, the consensus network will bypass the partitioned network link and all expected messages will be received within two communication rounds as long as all network nodes run as expected.

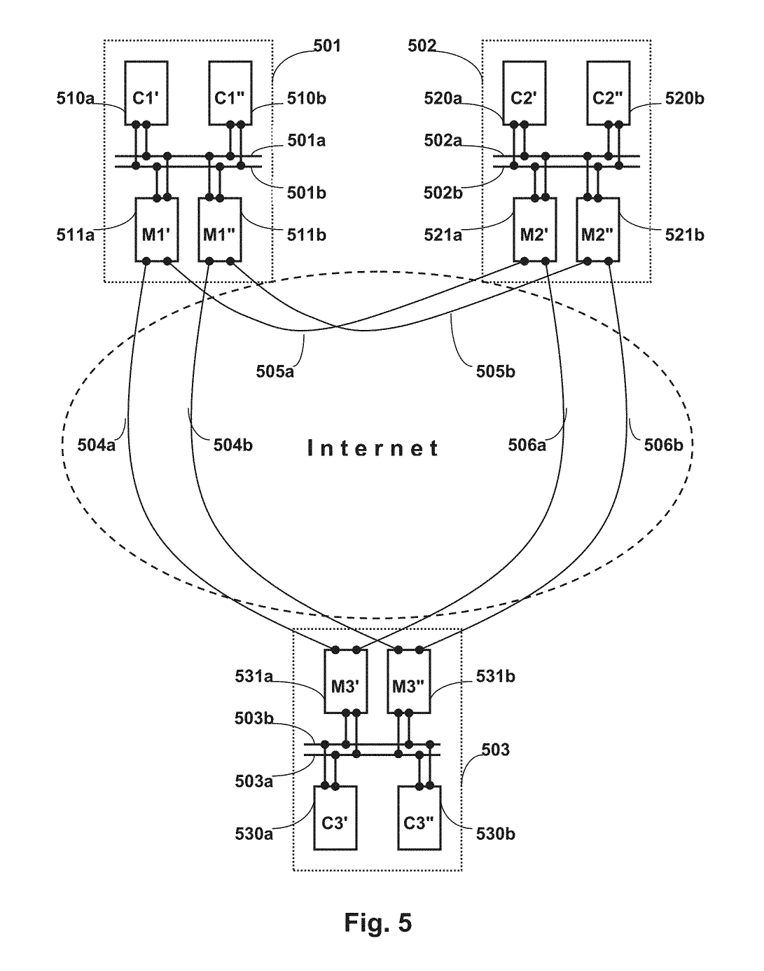

FIG. 5 is block diagram of a consensus network system of three nodes interconnected over the Internet using two Internet service providers per node and where each node is implemented as a cluster with highly available consensus messaging operations. The system comprises three computing clusters. Cluster 501 has 2 computers (510a and 510b) and 2 routing devices (511a and 511b) connected via pair of local area network segments (501a and 501b). Cluster 502 has 2 computers (520a and 520b) and 2 routing devices (521a and 521b) connected via pair of local area network segments (502a and 502b). Cluster 503 has 2 computers (530a and 530b) and 2 routing devices (531a and 531b) connected via pair of local area network segments (503a and 503b).

Each computing cluster uses two independent Internet service providers, one for each routing device. On the diagram, each routing device has established two point-to-point connections, each to a routing device of another computing cluster. On the diagram: 504a denotes a connection from 511a to 531a and a connection from 531a to 511a, 504b denotes a connection from 511b to 531b and a connection from 531b to 511b, 505a denotes a connection from 511a to 521a and a connection from 521a to 511a, 505b denotes a connection from 511b to 521b and a connection from 521b to 511b, 506a denotes a connection from 521a to 531a and a connection from 531a to 521a, and 506b denotes a connection from 521b to 531b and a connection from 531b to 521b.

Each computer and routing device of a cluster runs a network-link-clustering software module. This module implements an application layer transport protocol for reliable delivery of packets via multicast communication. In addition, each routing device implements an algorithm for establishing boundaries of a message in a stream of bytes received via point-to-point communication. A network-link-clustering module constructs and uses a listen socket object per local area network segment and a send socket per multicast destination group per local area network segment. In addition, each routing device constructs and uses a listen socket object per point-to-point connection and a send socket object per point-to-point connection. A network-link-clustering module transmits a message by duplicating the message on buffers of a pair of send socket objects and handling the transmission using both socket objects. A network-link-clustering module receives a message with involvement of two socked objects. A process on a computer sends a message by writing it to send buffer of the network-link-clustering module and reads a received message from read buffer of the network-link-clustering module.

Multicast of a message from one computer, say 510a, to every other computer in the system happens in the following manner. The network-link-clustering module on computer 510a multicasts the message to a multicast group that comprises computers 510a and 510b and routing devices 511a and 511b. On receiving the message, a routing device 511a transmits it over each one of connections 504a and 505a. On receiving the message, routing device 521a multicasts it to a multicast group that comprises routing devices 521a and 521b and computers 520a and 520b. On receiving the message, routing device 531a multicasts it to a multicast group that comprises routing devices 531a and 531b and computers 530a and 530b. Routing devices of clusters 501 and 502 take care to ensure delivery of the message from cluster 501 to cluster 502 regardless of possible partition of a link between routing device 511a and routing device 521a or a link between routing device 511b and routing device 521b. Routing devices of clusters 501 and 503 take care to ensure delivery of the message from cluster 501 to cluster 503 regardless of possible partition of a link between routing device bila and routing device 531a or a link between routing device 511b and routing device 531b.

Being part of a consensus network, the three nodes implemented as clusters (501, 502, and 503) participate in consensus protocol rounds. The max time a node may deviate from the other two nodes in moving from one protocol round phase to the next one is estimated in advance as well as the max time needed for a message from every node to be delivered to every other node. In the case where both connections between two nodes are partitioned due to congestion of a shared router or in the rare case where both connections simultaneously experience congested non-shared routers, a node will not receive an expected message within the expected time. Detecting simultaneous partition of connections over both network links with a timeout, the node broadcast a request for the missing message to the rest of the consensus network. Consensus protocols typically require a node to multicast its messages to all consensus network nodes. Once all nodes are up and running and the partition exists only between two nodes, the third node must have received the messages from the other two at the point of time when it received the request for the missing message. In response. the third node responds with sending the missing message to the requestor.

Having estimated the time interval of max deviation between switching of protocol round phases of any two nodes and the max time needed for a message from every node to be delivered to every other node in absence of network partition, lets estimate the max time interval necessary to guarantee the delivery of all message of a protocol round phase in cases of a network partition. Thus, to estimate the time interval with a guarantee termination of a consensus round before the interval expires.

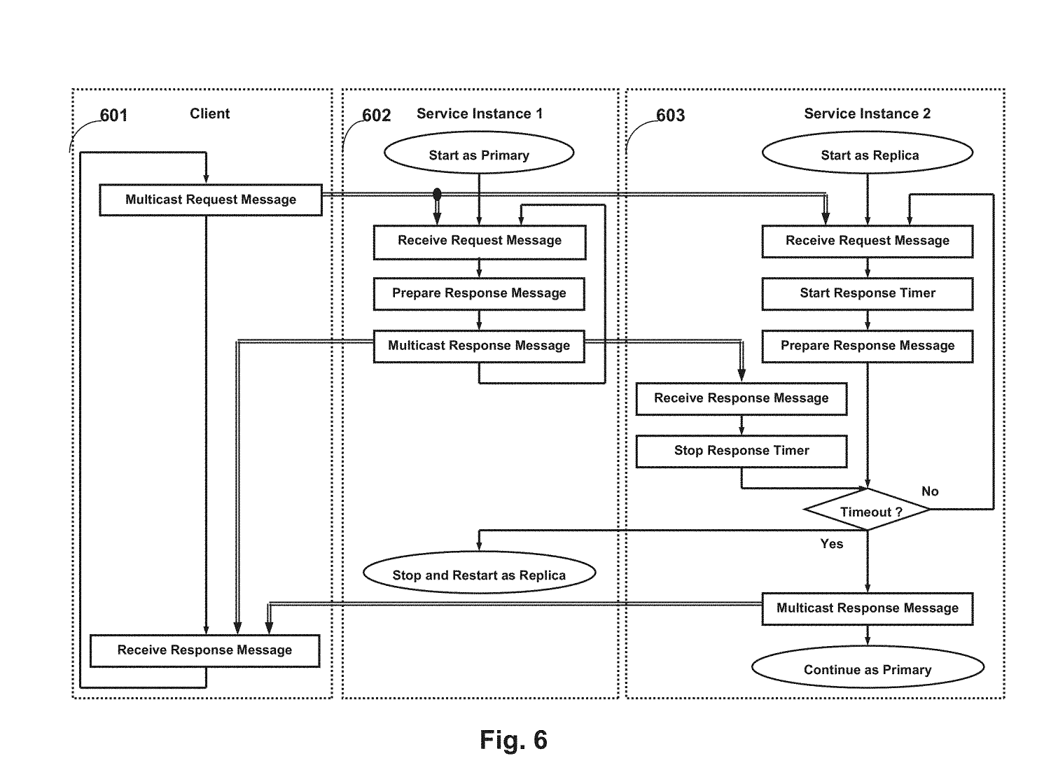

FIG. 6 is flowchart of detection, neutralization, and recovery of a stop-faulty process on a computer of a cluster of two computers. The method requires a minimal configuration comprising a client computer 601 running a client process and two server computers 602 and 603, each running an instance of service process. All three computers 601, 602, and 603 are interconnected via a local area network. The flowchart represents the interaction between the client process, the primary service process running on computer 602, and the replica service process running on computer 603. Objective of this method is to guarantee that each client request will receive a response regardless of a stop-fault of the primary service process.

The method comprises: 1) running a service process on the primary and the replica computers; 2) maintaining state of execution of the service process on the primary and the replica computers; 3) sending a message by the client computer for the primary computer via multicasting the message to the primary and replica computers; 4) starting a timer on the replica computer on receiving a message that needs a reply or the last message of a plurality of messages that needs a group reply; 5) using the timer to watch out for expiration of a timeout value specifying the maximum interval of time given to a primary computer to send a reply; 6) sending a message for the client computer via multicasting the message to the client computer and to replica computer.

On event of a received message from the client computer: 1) the replica service starts a timer; 2) the primary and the replica services process the received message and prepare a reply message; 3) on readiness of a reply message the primary service multicasts it. On event of a received reply message from the primary process, the replica service stops the timer related to the received client message. On event of a timeout, the replica service: 1) triggers a stop and restart procedure of the primary service process, 2) promotes itself as primary service, and 3) multicasts the message that ex primary service failed to multicast. On event of a completed recovery of an ex primary service, it assumes the role of replica service.

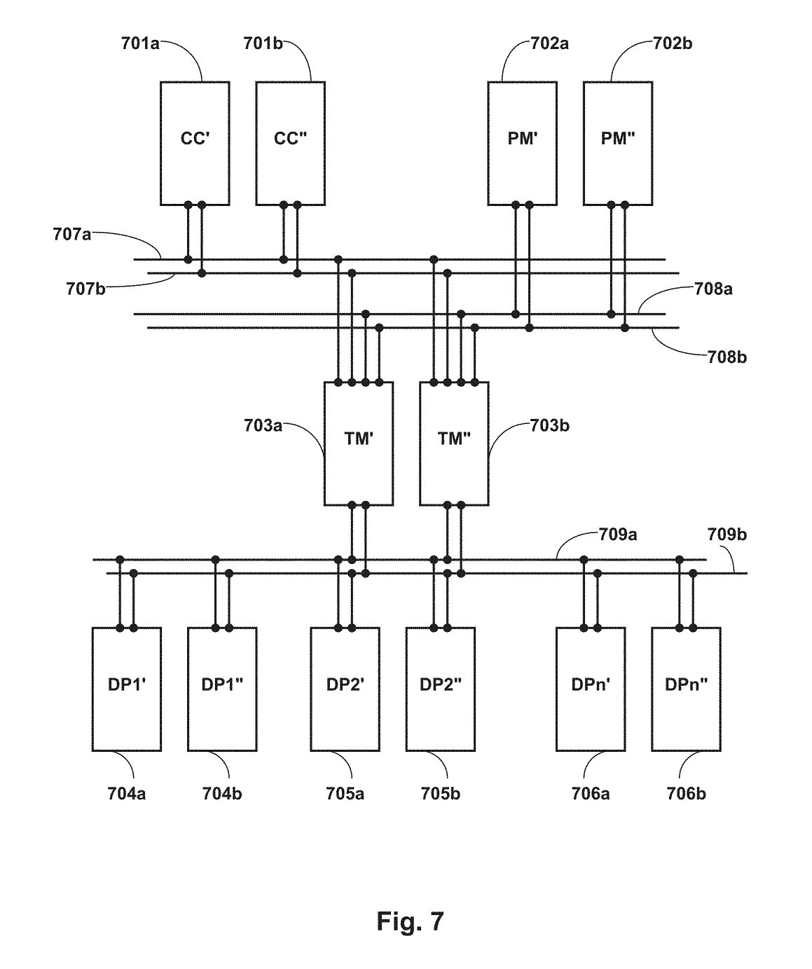

FIG. 7 is block diagram of a blockchain node built as a cluster of computers with resilient operations ensured with redundant communication paths and replicated functional elements. The node ensures high-availability of horizontally scaled data by performing highly available deterministic transactions requested by node clients and clients of all other nodes of the ledger that are partners in establishing consensus about a common sequential order of execution of all transactions requested by all clients of the ledger. Functional groups of the node are: clients communication, partners multicast, communication & transaction management, and data management per data partition. As a functional group, the communication & transactions management performs two distinctive tasks: 1) executing a consensus protocol algorithm that orders the requested transactions and 2) executing the actual transactions. The communication & transactions management group interacts with every other functional group using multicast messaging with guaranteed delivery.

On the diagram blocks 701a and 701b represent computers for communication with clients, blocks 702a and 702b represent computers for multicast with partners, blocks 703a and 703b represent communication & transactions management computers, blocks 704a and 704b represent data management computers for data partition 1, blocks 705a and 705b represent data management computers for data partition 2, and blocks 706a and 706b represent data management computers for data partition n. The clients communication computers and the communication & transactions management computers interact between themselves over a pair of local area network segments 707a and 707b. The partners multicast computers and the communication & transactions management computers interact between themselves over a pair of local area network segments 708a and 708b. The data management computers and the communication & transactions management computers interacts between themselves over a pair of local area network segments 709a and 309b.

The transaction management executes the requested transactions on both primary and replica transaction manager computers in following manner: 1) each of the transaction managers maintains data item locks in its main memory; 2) each of the transaction managers obtains locks on the necessary for transaction execution data items that may conflict with any other transaction; 3) the primary transaction manager requests transaction input data from one of data managers per involved data partition; 4) the data manager multicasts the requested transaction input data to both transaction manager computers; 5) each of the transaction managers executes a transaction program associated with the requested transaction in its main memory and then releases the locks; 6) the primary transaction manager multicasts a request to make transaction outcome data durable to both data manager computers per involved data partition where the received requests are performed in a linearizable manner, which means under exactly the same serial order.

The high-availability of horizontally scaled data and high-availability of transactions with the horizontally scaled data is achieved with detection the effect of a faulty transaction manager or data manager and neutralization the effect of a faulty transaction manager. The sub-system for these comprises:

1) A computer that sends transaction request messages by multicasting each message to both transaction manager computers and a computer that receives transaction response messages, where the request sending computer and the response receiving computer can be but not necessarily are the same computer;

2) A primary transaction manager computer that: A) receives transaction request messages; B) sends ‘read data’ request messages, each message directed to one of data managers per involved data partition, by multicasting the message to the data manager and to the replica transaction manager; C) starts a timer on sending a ‘read data’ request message to a data manager; D) receives ‘read data’ result messages with from the requested data managers; E) stops a timer on receiving a ‘read data’ result message with from the requested data manager; F) executes each transaction in its main memory with the ‘read data’ result, prepares transaction response message and transaction ‘write data’ request; G) sends ‘write data’ request messages by multicasting each message to both data managers and to the replica transaction manager; H) starts a timer on sending a ‘write data’ request message to data managers; I) receives ‘write data’ result messages from the requested data managers; J) stops a timer on receiving a ‘write data’ result message from all requested data managers; K) sends transaction response messages by multicasting each message to the client and to the replica transaction manager; L) on recovery after a failure, rebuilds its state from the current primary transaction manager and becomes the replica transaction manager computer; M) on timeout triggers a recovery of the stop-faulty data manager;

3) Data manager computers that: A) receive ‘read data’ request messages; B) perform ‘read data’ operations; C) send ‘read data’ result messages by multicasting each message to both transaction managers; D) receive ‘write data’ request messages; E) perform ‘write data’ operations; F) send ‘write data’ result messages by multicasting each message to both transaction managers;

4) A replica transaction manager computer that: A) uses timers to detect expiry of a timeout value specifying the maximum interval of time given to the primary transaction manager to send a message; B) starts a timer on receiving a transaction request that requires the primary transaction manager to send a ‘read data’ request message; C) stops the timer on receiving a ‘read data’ request message from the primary transaction manager; D) receives ‘read data’ result messages with from the requested data managers; E) executes each transaction in its main memory with the ‘read data’ result, prepares transaction response message and transaction ‘write data’ request; F) starts a timer on readiness of a transaction ‘write data’ request; G) stops the timer on receiving a ‘write data’ request message from the primary transaction manager; H) starts a timer on receiving a ‘write data’ result message from a data manager; I) stops the timer on receiving a transaction response message from the primary transaction manager; J) on timeout triggers a recovery of the primary transaction manager, becomes the new primary transaction manager, continues the execution of each started but not completed transaction.

To increase the overall throughput, the transaction manager does not make the outcome of a transaction durable immediately after the transaction execution and its commit in manager's main memory. Instead, the outcome of a group of transactions committed in the memory are later committed durably as part of a group commit with a single write operation. A group commit changes the execution of a transaction in the following manner: 1) before the primary transaction manager requests transaction input data from one of data managers per involved data partition, the manager checks whether a more recent version of that data exists in the transaction outcome waiting for a group commit; 2) the replica transaction manager does not wait for multicast of input data performed by the requested data manager if a more recent version of that data exists in its own transaction outcome waiting for a group commit.

The high-availability of horizontally scaled data and high-availability of transactions with the horizontally scaled data is achieved with detection the effect of a faulty transaction manager or data manager and neutralization the effect of a faulty transaction manager. The sub-system for these comprises:

1) A computer that sends transaction request messages by multicasting each message to both transaction manager computers and a computer that receives transaction response messages, where the request sending computer and the response receiving computer can be, but not necessarily are, the same computer;

2) A primary transaction manager computer that: A) receives transaction request messages; B) sends ‘read data’ request messages, each message directed to one of data managers per involved data partition, by multicasting the message to the data manager and to the replica transaction manager; C) starts a timer on sending a ‘read data’ request message to a data manager; D) receives ‘read data’ result messages with from the requested data managers; E) stops a timer on receiving a ‘read data’ result message from the requested data manager; F) executes each transaction in its main memory with the ‘read data’ result, prepares transaction response message and transaction ‘write data’ request; G) sends ‘write data’ request messages by multicasting each message to both data managers per involved partition and to the replica transaction manager; H) starts a timer on sending a ‘write data’ request message to data managers; I) receives ‘write data’ result messages from the requested data managers; J) stops a timer on receiving a ‘write data’ result message from all requested data managers; K) sends transaction response messages by multicasting each message to the client and to the replica transaction manager; L) on recovery after a failure, rebuilds its state from the current primary transaction manager and becomes the replica transaction manager computer; m) on timeout triggers a recovery of the stop-faulty data manager;

3) Data manager computers that: A) receive ‘read data’ request messages; B) perform ‘read data’ operations; C) send ‘read data’ result messages by multicasting each message to both transaction managers; D) receive ‘write data’ request messages; E) perform ‘write data’ operations; F) send ‘write data’ result messages by multicasting each message to both transaction managers;

4) A replica transaction manager computer that: A) uses timers to detect expiry of a timeout value specifying the maximum interval of time given to the primary transaction manager to send a message; B) starts a timer on receiving a transaction request that requires the primary transaction manager to send a ‘read data’ request message; C) stops the timer on receiving a ‘read data’ request message from the primary transaction manager; D) receives ‘read data’ result messages with from the requested data managers; E) executes each transaction in its main memory with the ‘read data’ result, prepares transaction response message and transaction ‘write data’ request; F) starts a timer on readiness of a transaction ‘write data’ request; G) stops the timer on receiving a ‘write data’ request message from the primary transaction manager; H) starts a timer on receiving a ‘write data’ result message from a data manager; I) stops the timer on receiving a transaction response message trom the primary transaction manager; J) on timeout triggers a recovery of the primary transaction manager, becomes the new primary transaction manager, continues the execution of each started but not completed transaction.

The high-availability of a transaction management is achieved with recovery of a faulty transaction manager and making its soft state atomically consistent with the soft state of the healthy transaction manager. The performed activities involve: 1) detecting a faulty transaction manager; 2) triggering a recovery procedure; 3) restarting the receiving of transaction requests by the recovered transaction manager; 4) sending a notification from the recovered transaction manager to the healthy transaction manager with the first received transaction request after the recovery; 5) stopping the transaction processing with the healthy transaction manager after execution of the last transaction request that is not received by the recovered transaction manager; 6) copying the transaction management soft state from the healthy transaction manager to the recovered transaction manager; 7) restarting the transaction processing on both transaction managers from the first received but not yet processed transaction request.

The high-availability of horizontally scaled data is achieved with recovery of a faulty data manager and making its state atomically consistent with the other data manager of same data partition. The activities performed by a transaction manager with these objectives are: 1) detecting a faulty data manager; 2) triggering a recovery procedure; 3) detecting a recovered data manager; 4) preserving in memory all group commit request messages from the detection until the recovery; 5) sending to the recovered data manager all preserved group commit request messages.

The activities performed by the recovered data manager are: 1) switching to non-blocking atomic ‘write data’ operations; 2) executing by the preserved group commit request messages; 3) receiving and preserving all group commit request messages incoming during the execution of the non-executed group commit requests; 4) continuing the execution of non-executed group commit requests and the receiving of new group commit request messages until there is no more non-executed group commit requests; 5) switching back to blocking atomic ‘write data’ operations.

The horizontally scaled data is further scaled horizontally by scaling out the data management. The performed activities involve: 1) connecting data management computers for the new data partition to the pair of local area network segments 709a and 709b; 2) creating a pair of multicast groups on the networking equipment of the pair of local area network segments 709a and 709b; 3) constructing socket objects on transaction managers and on data managers of the new data partition for sending and receiving data requests; 4) constructing socket objects on transaction managers and on data managers of the new data partition for sending and receiving responses to data requests; 5) constructing objects on the transaction managers to facilitate direction of data requests to the new data partition; 6) constructing objects on the transaction managers to facilitate control of the timing of sent data requests and received responses to the requests to the new data partition.

In cases where a node has to build and maintain a synchronized replica of a relational database, but the data manager computers of the cluster run key-value store software as data manager, a transaction manager performs the following: 1) during read operations maps the value data of a read key-value item to a structure object where each individual member of the structure represents the value of a column field of a record in a table of a relational database; 2) during transaction execution in its main memory uses the structure object as representative of relational database table record; and 3) during data write operations maps a record of a table of a relational database represented as a structure object to the value data of a key-value item that will be written.

To let a compiled and built transaction manager provide its ACID guarantees to unlimited range of existing and to be created databases, implemented on relational database management systems or on key-value data stores, and to enable horizontal scalability of data management, the transaction manager has an ability to execute unlimited plurality of units of program code not known to the transaction management process at compile time. These units of executable program code are invoked as methods of an interface known to the transaction manager at its own compile time. During transaction manager start, the necessary pieces of executable program code are created from files containing binary code. These pieces of executable code are invoked by the transaction manager and executed under the protection of ACID transaction guarantees.

Time-bound delivery of messages in a consensus network circumvents CAP theorem. High-availability of a consensus node circumvents the FLP result. These are sufficient to ensure both safety and liveness of consensus under an assumption of non-existence of Byzantine faults. Such an assumption is not reasonable in the context of possible random behavior of software and possible malicious behavior of a node operator. A Byzantine consensus protocol is expected to tolerate up to a certain number of stop-faulty or Byzantine-faulty nodes. This means that faulty nodes within the tolerated limit cannot affect the protocol safety. In contrast, just a single Byzantine-faulty node can spoil the liveness of consensus algorithm when this node performs the role of protocol leader. The protocol leader is in a position letting deliberately delay the start of a new consensus round. Until the consensus network detects the deliberate delay and performs the procedure electing a new leader, the consensus algorithm will have no liveness and the network will be unavailable to serve clients requests. Elimination of the need of a leader requires deterministic composition of value that a protocol round will try to establish consensus about.

Consensus algorithm executed by the communication & transaction management uses a leaderless Byzantine consensus protocol. Being leaderless means that no one of nodes of a consensus network is on the privileged position to propose which set of the transactions requested by network clients are to be included in the total set of transactions for a particular cycle of the consensus protocol or to establish the sequential order within the proposed total set of transactions. Letting a leader make such non-deterministic choice is against the goal of the decentralized ledgers of not allowing a single node influence the outcome of a consensus protocol. Objective of the eliminated need of a leader is to make it impossible for a faulty node software or a dishonest node operator or hacked operations of a node to negatively affect the safety of consensus protocol or the liveness of consensus algorithm.

A variety of rules can be used for deterministic composition of value that a protocol round will try to establish consensus about. In the embodiment of this invention, the rules obey the following restrictions: 1) the relative order between the transaction requests received by a node directly from clients of the consensus network is relevant and significant; 2) the relative order of receiving individual sets containing relatively ordered transaction requests, where each set is received as a result of a multicast performed by a peer node of the consensus network, is irrelevant and insignificant. The exact logic behind these rules does not really matter. The spirit of this invention is to replace the need of a proposer making a non-deterministic choice with a set of deterministic rules executed in an asynchronous network.

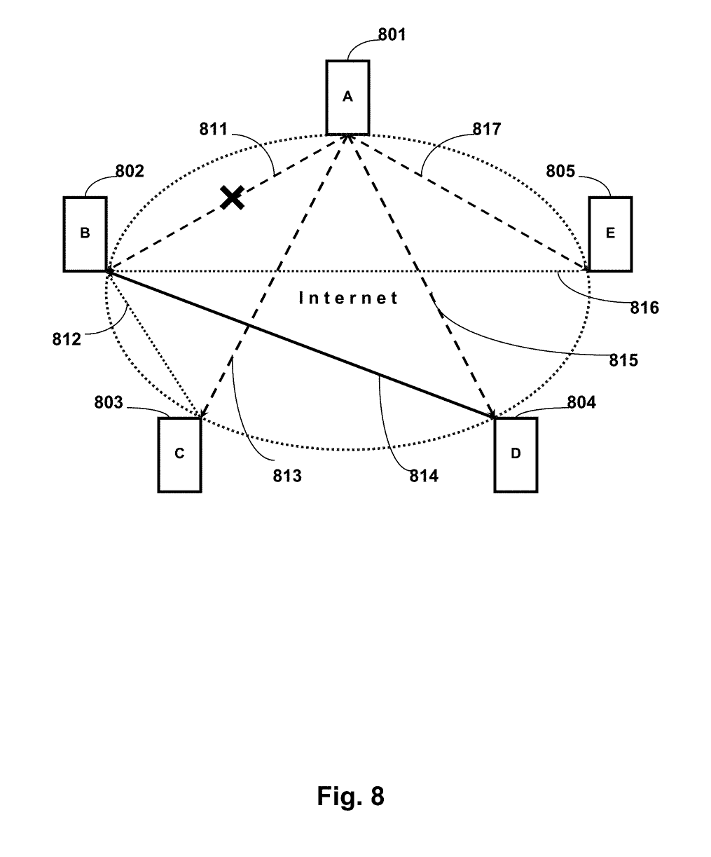

FIG. 8 is block diagram of a consensus network system of five nodes implemented over the Internet and ensuring time-bound delivery of messages despite the existence of a network partition and two Byzantine nodes. Network's five nodes 801, 802, 803, 804, and 805 are implemented in a way ensuring high availability of the essential operations of each node. The nodes are interconnected in a way ensuring delivery of messages each node multicasts to all other nodes, except in cases the two network links between any two nodes share a router and this router becomes congested. The diagram demonstrates that the time-bound delivery of messages will not be spoiled by the existence of two Byzantine nodes that may deliberately violate the protocol by not responding to a request for indirect transmissions of a non-received message.

On the diagram, nodes 803 and 805 are Byzantine-faulty and the network link partition is between nodes 801 and 802. Every node possesses the public key of all other nodes in the network. Node 801 multicasts a signed message over network links 811, 813, 815, and 817. Nodes 803, 804, and 805 received this message. Node 802 has not received it as a result of the partition of network link 811. Node 802 multicasts a request for the missing message over network links 811, 812, 814, and 816. Nodes 803, 804, and 805 receive the request. Nodes 803 and 805 being Byzantine-faulty do not respond, but node 804 responds with sending the message over network link 814. Node 802 having received the message from node 804 verifies the signature of node 801 on the indirectly received message. If the signature confirms that the sender is node 801, node 802 confidently uses the message as if it was received directly from node 801.

The embodiment of this invention operates with a proprietary synchronous leaderless Byzantine consensus protocol. The protocol itself is a module that may be replaced with another synchronous Byzantine consensus protocol, as long as it is leaderless and the exchanged messages are signed by the sending node. What lets any synchronous leaderless Byzantine consensus protocol operate in asynchronous environment is an asynchronous algorithm that capitalizes on the clustered architecture of consensus network nodes and the high availability of intra-node data transactions to defuse the effect of stop-faulty processes and to bypass the partitioned network links. Any leaderless Byzantine consensus protocol can achieve consensus in two phases. During phase One, each network node distributes a sequentially ordered set of received from its clients requests for transactions to all other network nodes. During phase Two, each network node distributes its proposed full set of transactions to commit at this consensus round.

The typical leaderless Byzantine consensus protocol messages are: 1) PH1_D, which denotes Phase One Data and contains full text and signatures of all transaction requests a node has received; 2) PH2_D, which denotes Phase Two Data and contains the entire set of ordered and validated transaction IDs for this consensus. During regular completion of protocol phases, the algorithm uses only the protocol messages.

To handle timing irregularities, the algorithm uses four additional messages: 1) PH1_N, which denotes Not Received PH1_D from a list of nodes and is used to request indirect transmission; 2) PH1_R denotes a reply to PH1_N and contains some or all of the non-received PH1_D messages; 3) PH2_N denotes Not Received PH2_D from a list of nodes and is used to request indirect transmission; 4) PH2_R denotes a reply to PH2_N and contains some or all of the non-received PH2_D messages.

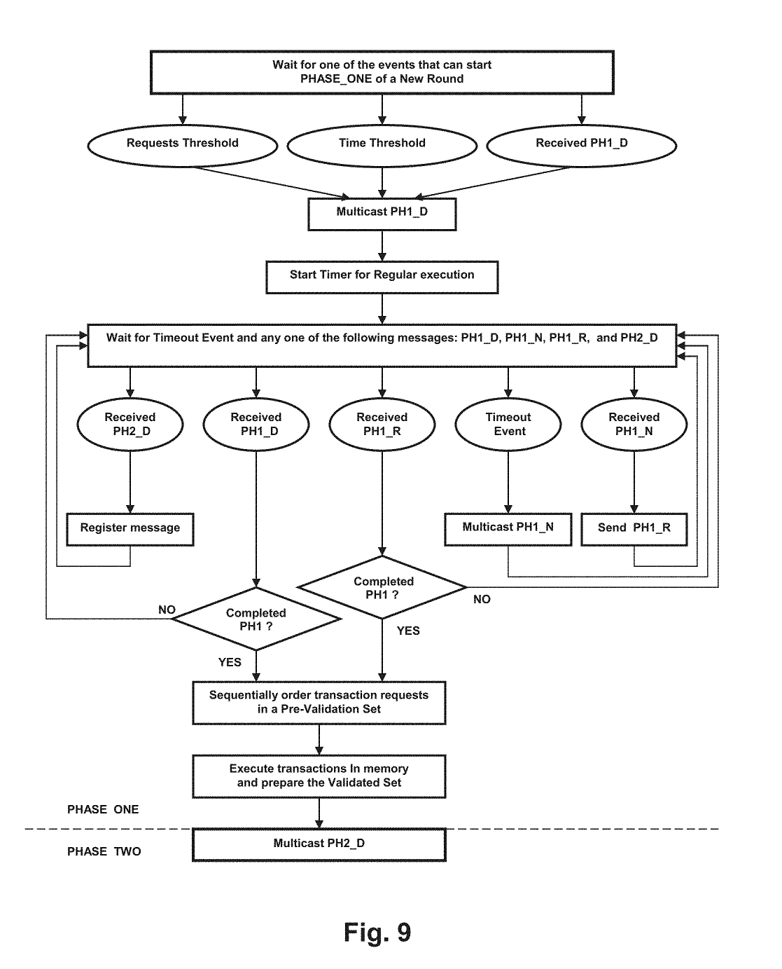

FIG. 9 is flowchart of the algorithm for execution of phase One of a synchronous leaderless Byzantine consensus protocol in asynchronous communication environment. Start of phase One of the algorithm may be triggered by each one of the following events: 1) reached the threshold of received requests for transaction; 2) reached the time threshold waiting to reach the threshold of received requests for transaction; or 3) Received PH1_D message indicating that another nodes has already started phase One. A node begins phase One with multicasting its own PH1_D message, starting a timer for regular execution, and entering wait for a timeout or for receiving one of the following messages from the other network nodes: PH1_D, PH1_N, PH1_R, or PH2_D. On receiving a PH1_D message, the algorithms checks whether condition for completion of phase One are presented. If not, the algorithm enters wait. On timeout, the algorithm multicasts PH1_N and enters wait. On receiving PH1_N, the algorithm sends PH1_R to the requesting node and enters wait. On receiving PH1_R, the algorithms checks whether condition for completion of phase One are presented. If not, the algorithm enters wait. On receiving PH2_D, the algorithm registers the message and enters wait. When condition for completion of phase One are presented, the algorithm orders sequentially the transaction requests in a pre-validation set, executes the transactions in memory, prepares the validated set, and multicasts PH2_D, which starts execution of phase Two.

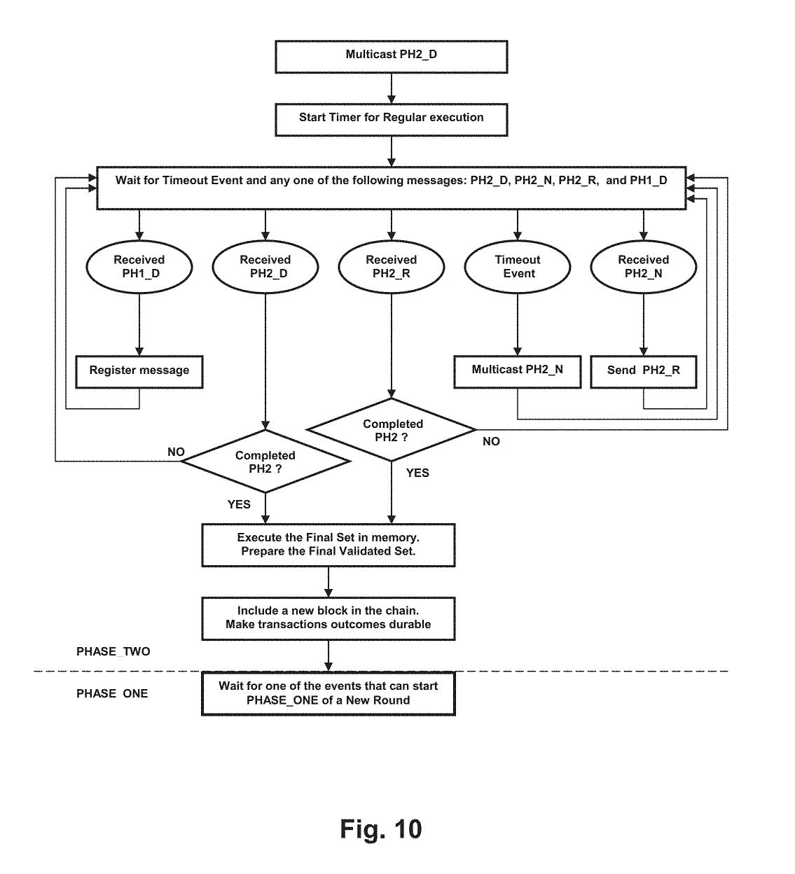

FIG. 10 is flowchart of an algorithm for execution of phase Two of a synchronous leaderless Byzantine consensus protocol in asynchronous communication environment. After multicasting PH2_D and starting the timer of regular execution, the algorithm enters wait for a timeout or for receiving one of the following messages from the other network nodes: PH2_D, PH2_N, PH2_R, or PH1_D. On receiving a PH2_D message, the algorithms checks whether condition for completion of phase Two are presented. If not, the algorithm enters wait. On timeout, the algorithm multicasts PH2_N and enters wait. On receiving PH2_N, the algorithm sends PH2_R to the requesting node and enters wait. On receiving PH2_R, the algorithms checks whether condition for completion of phase Two are presented. If not, the algorithm enters wait. On receiving PH1_D, the algorithm registers the message and enters wait. When condition for completion of phase Two are presented, the algorithm executes the final set in memory, prepares the final validated set, includes a new block in the blockchain, makes the transaction outcomes durable, and enters wait for conditions that can trigger execution of phase One of the next round of the consensus algorithm.

The core of this invention is the design and implementation of transactions that transfer units of a crypto token across blockchain networks that operate with time-bound deterministic consensus. Main purpose of transactions is to guarantee safe execution of groups of operations. The term cross-chain transaction denotes execution of a business operation involving transfers of crypto tokens from an account in the ledger of a sending blockchain network to an account in the ledger of a recipient blockchain network in exchange for a digitally signed receipt, wherein the transfer is performed with the safety properties of a database transaction.

Secure transfer of value from an account in the ledger of one blockchain network to an account in the ledger of another blockchain network requires services of an entity with accounts in the ledgers of both networks. Entity's account in the recipient's ledger makes the payment and entity's account in the sender's ledger receives reimbursement from the sender. Such interoperability does not require and does not involve transfer of tokens across ledgers of two blockchain networks. However, if payments between two ledgers go dominantly in one direction, the liquidity in the entity's account in the recipient network may easily drain out and the interledger payments will have no other option but to stop. Making cross-ledger payment transactions independent from the requirement for balanced payments in both direction requires facilitation of cross-ledger transfer of tokens.

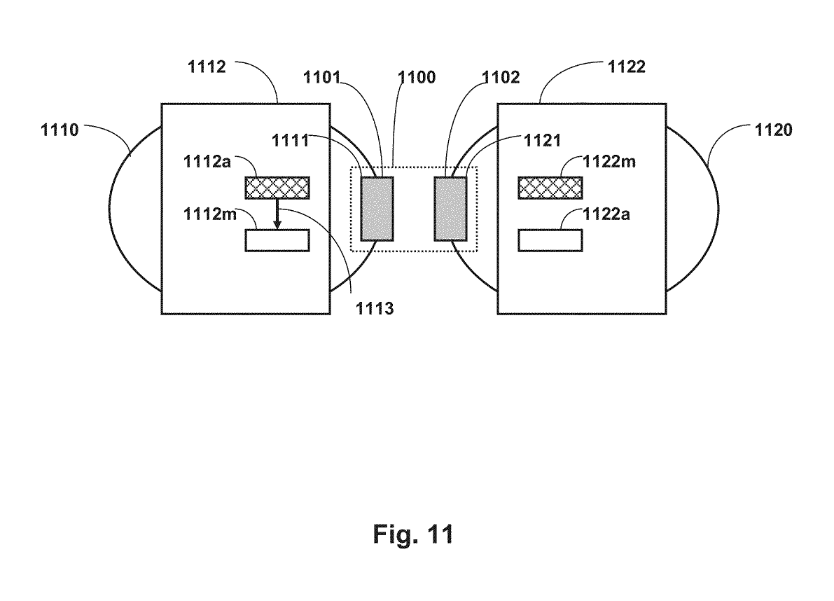

FIG. 11 is block diagram of ledgers of two interconnected blockchain networks and the first of two intra-ledger transactions that implement cross-chain transfer of units of crypto tokens. Blockchain network 1110 and blockchain network 1120 do not present all network nodes for simplicity. The block diagram presents only node 1111 of network 1110 and node 1121 of network 1120. These nodes, 1111 and 1121, belong to the same business entity 1100 called facilitator as it facilitates the transfer of tokens across these blockchain networks. Ledger 1112 is the ledger of blockchain network 1110 and ledger 1122 is the ledger of blockchain network 1120. Facilitator entity owns an account 1112a in ledger 1112 and an account 1122a in ledger 1122 and a meta-account 1112m in ledger 1112 and a meta-account 1122m in ledger 1122. These meta accounts facilitate transfer of tokens between ledgers 1112 and 1122. Meta-account 1112m represents on ledger 1112 the content of account 1122a in ledger 1122. Meta-account 1122m represents on ledger 1122 the content of account 1112a in ledger 1112.

The content of an account in a blockchain ledger is an existing digital asset or a plurality of existing digital assets. This asset, or a plurality of assets, is under control of the account owner. In regard to facilitator's accounts, such control does not mean that a human representative of the facilitator entity has to authorize individual transactions with the assets in these accounts. Instead, a software component, the preferred embodiment of this invention implemented as parameterized instance of a COM class, containing a set of parameterized business rules is loaded on the facilitator node and acts as agent on behalf of the facilitator entity submitting authorized transaction requests. The first intra-ledger transaction that implements cross-chain transfer of units of a crypto token may be authorized by the facilitator agent or by a representative of the facilitator. This intra-ledger transaction 1113 transfers the authorized amount of token units from account 1112a to meta-account 1112m.

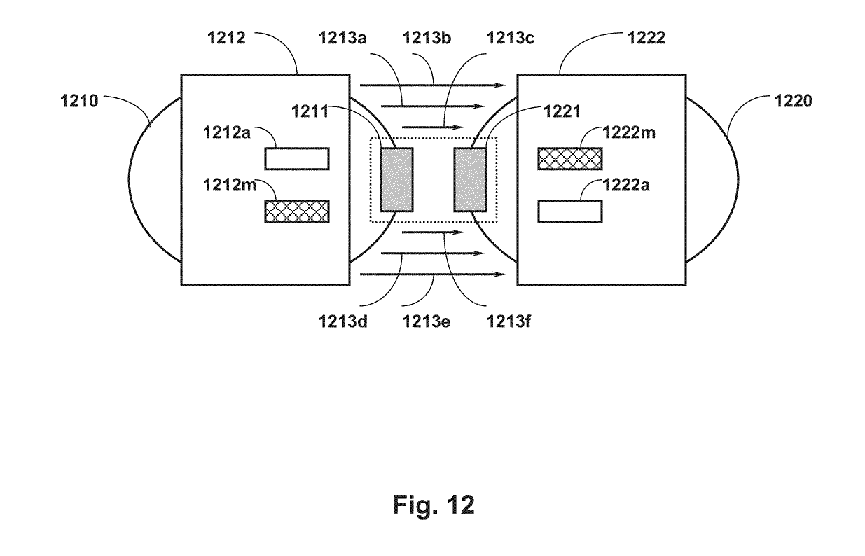

FIG. 12 is block diagram of ledgers of two interconnected blockchain networks and the messages that relate both intra-ledger transactions of a cross-blockchain transfer of units of crypto tokens. Interconnection of two blockchain networks means that every node of each network has an open connection to every node of the other network. Once the intra-ledger transaction is committed on a node of the blockchain network 1210 and the transferred amount of token units is in meta-account 1212m of ledger 1212 copy on that node, the node sends a notification message to every node of blockchain network 1220. On the diagram, messages 1213a, 1213b, 1213c, 1213d, 1213e, and 1213f indicates multicasting of notification messages from the nodes of blockchain network 1210 to the nodes of blockchain network 1220.

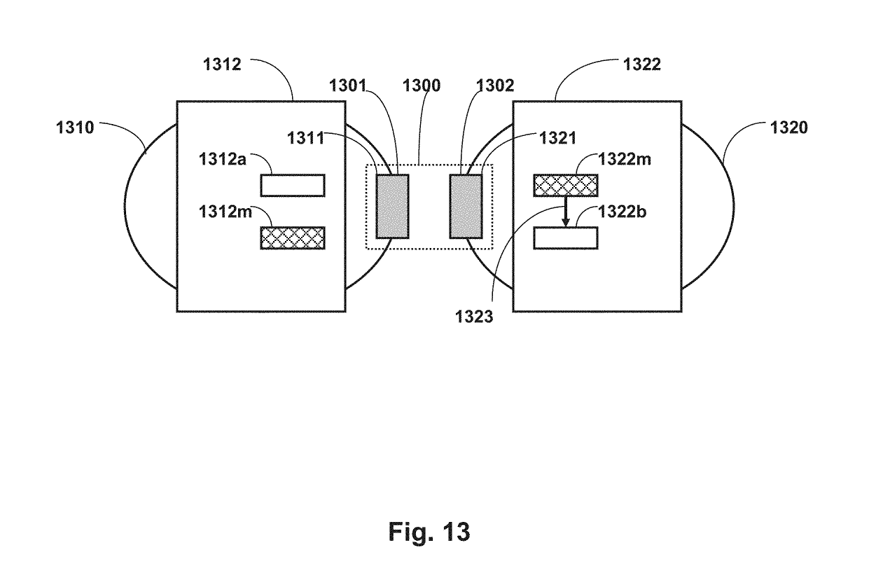

FIG. 13 is block diagram of ledgers of two interconnected blockchain networks and the second of two intra-ledger transactions that implement cross-chain transfer of units of crypto tokens. This intra-ledger transaction 1323 has to be initiated and authorized by the agent of the facilitator entity 1300. This agent runs on the facilitator owned node 1302 of blockchain network 1320. Before the transaction 1323 becomes validated, its initiation has to be approved by F+1 nodes of blockchain network 1320. An honest node of network 1320 will approve its initiation if it has received notification messages from F+1 nodes of network 1310 confirming the successfully committed intra-ledger transaction that performed the transfer from account 1312a to meta-account 1312m on ledger 1312. F+1 honest nodes of network 1320 will approve the initiation of the transaction 1323 if and only if the transaction 1323 is going to replicate on ledger 1322 the committed and confirmed transaction on ledger 1312. Once the initiation of transaction 1323 is approved and validated, it becomes executed and committed by blockchain network 1320. As a result of that, the units of a crypto token transaction 1323 transferred from meta-account 1322m to account 1322a are under the complete control of the facilitator entity 1300 via its human representative or via its software agent running on node 1302.

This way implemented cross-chain transfer of units of a crypto token between accounts owned by the facilitator entity in the ledgers of two interconnected blockchain networks serves as a bridge between the two ledgers and a building block in devising a cross-chain transfer from any account in one ledger to any account in the other ledger. Implementation of such transfer with the safety of a cross-chain transaction requires one additional building block. On the sender's ledger there must exist an escrow account under control of the sender's blockchain network via escrow contract. Purpose of the escrow contract is to guarantee atomic execution of the involved intra-chain transactions that transfer ownership of units of crypto tokens as part of a general cross-chain transaction. In contrast, the intra-chain transactions that implement cross-chain transfer between accounts owned by the facilitator do not transfer ownership.

An escrow contract is a parameterized instance of event-driven state-machine workflow with deterministic execution on all nodes of a blockchain network. An instance is parameterized with initialization of its control state, workflow state, and data state. The workflow is itself defined with its: a) workflow state transitions; b) pieces of execution code that enact transitions of the workflow state; c) events that trigger the transitions of the workflow state; and d) transactions in the local copy of ledger's database that are executed to reflect the transitions of the state. Events typically modify the control state and data state, and trigger the execution of code that enact transitions of the workflow state, which may invoke execution of transactions in the local copy of ledger's database.

In the preferred embodiment of this invention, an event-driven state-machine workflow is implemented as COM class. The COM class is programmed as a contract template indicating actions that must be performed in time or in response to predetermined external events. Similarly to the way a template for paper contracts needs to indicate some more specific details in order to become a contract body, the required behavior of an instance of the COM class needs to be parameterized with initialization of its control state, workflow state, and data state. Execution of an intra-chain transaction as part of an escrow contract may be initiated by any node, but has to be approved by F+1 nodes in order to be submitted as transaction request for validation. The preferred way of initiation is by the initiative of the party that benefits from it—the agent of the facilitator or an agent of the sender. Agent of the sender is an instance of a COM class created on the node that received the sender's request after the receiving of sender's request for a cross-chain transaction and terminated after termination of the escrow contract instance on that node.

Typically, a paper contract signed by the party that makes an offer legally binds the offering party to the terms and conditions of the contract until the offer expires. Similarly, an account in a ledger initiates the creation and parameterization of an event-driven state-machine workflow instance by requesting a crypto asset under the its control to be placed in escrow account under the control of the workflow instance. Sending a crypto asset in an escrow account under specified conditions is the IT equivalent of making a one-party-signed contract offer. Satisfying by the offered party the conditions of the offer before it expires is the equivalent to both parties signed and executed contract.

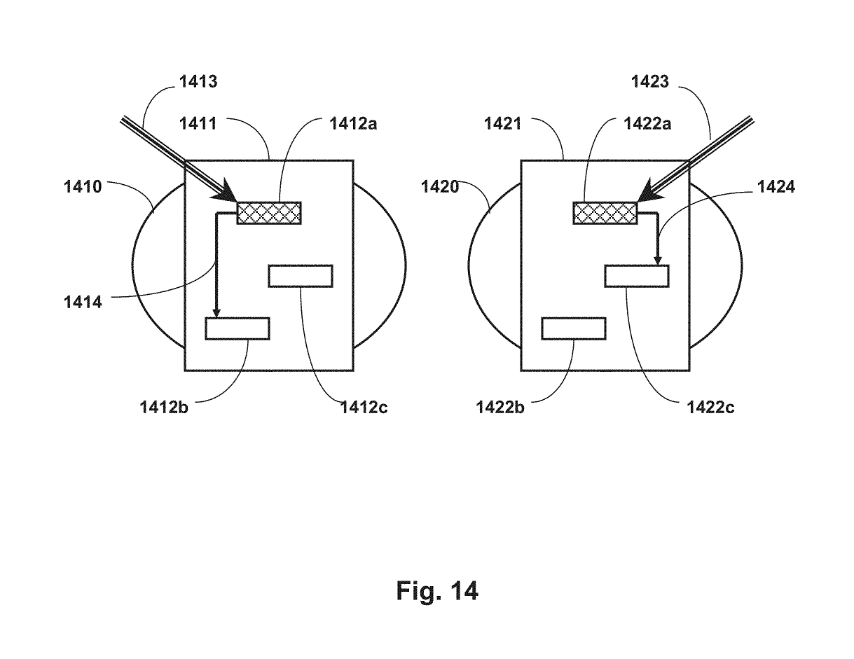

FIG. 14 is block diagram of the ledger of a blockchain network, an escrow account and the two possible outcomes of an escrow contract that controls the escrowed content. One of the possible outcomes of the escrow contract is presented on the ledger 1411 of blockchain network 1410. Account 1412b is the sender's account, account 1412a is the escrow account, and account 1412c is the facilitator's account. The escrow contract starts after units of a crypto token from the sender's account are received in the escrow account and will complete by either a Confirmation event or a Timeout event—whichever happens first. Event 1413 is Timeout event, which happens before Confirmation event. As a result of it, the escrow contract completes with execution of an intra-ledger transaction 1414, which returns the units of a crypto token in the escrow account that are controlled by the escrow contract back to the sender's account 1412b. Blockchain network 1420 is the same blockchain network 1410, ledger 1421 is the same ledger 1411, and account 1422a is the same escrow account 1412a. Event 1423 is Confirmation event, which happens before Timeout event. As a result of it, the escrow contract completes with execution of an intra-ledger transaction 1424, which sends the units of a crypto token in the escrow account that are controlled by the escrow contract forward to the facilitator's account 1422c.

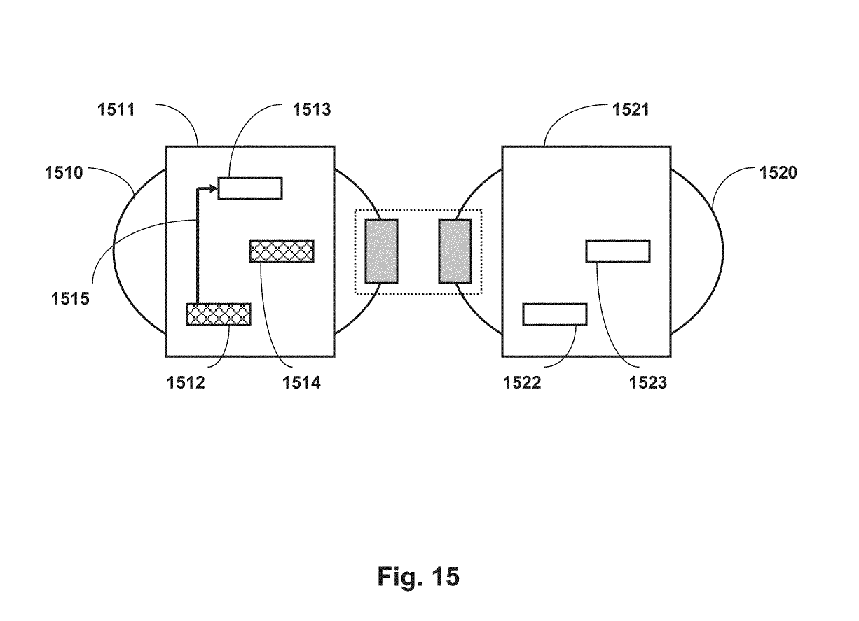

FIG. 15 is block diagram of ledgers of two interconnected blockchain networks and step One of a cross-chain transaction transferring tokens from any account to any account. Blockchain network 1510 maintains ledger 1511 and blockchain network 1520 maintains ledger 1521. The owner of account 1512 in ledger 1511 requests from blockchain network 1510 transfer of XXX units of a crypto token from account 1512 in ledger 1511 to a recipient account 1523 in ledger 1521. Account 1514 in ledger 1511 belongs to the business entity that facilitates transfer of units of a crypto token between ledgers of blockchain networks 1510 and 1520. Account 1522 in ledger 1521 belongs to the same facilitator business entity.

Payment of XXX units of a crypto token from account 1512 in ledger 1511 to a recipient account 1523 in ledger 1521 does not inevitably require transfer of XXX units of a crypto token from ledger 1511 to ledger 1521. Such transfer may be avoided by payment of XXX units from the facilitator account 1522 in ledger 1521 to the recipient account 1523 and facilitator account 1514 in ledger 1521 receiving reimbursement of XXX units and Y units commission. With such implementation, if payments between two ledgers go dominantly in one direction, the liquidity in the facilitator's account in the recipient ledger may drain out and the cross-ledger payments will have no other option but to stop. With no cross-ledger transfer of tokens, the availability of a cross-ledger payment service depends on the balance of payments in both direction.

Before the node of blockchain network 1510 (which received the request to transfer XXX units of a crypto token from account 1512 in ledger 1511 to a recipient account 1523 in ledger 1521) initiates the cross-ledger transaction, the node verifies that the facilitator's account 1514 in fact contains at least XXX units of the crypto token. The facilitator entity is under contractual obligation with the nodes of the interconnected blockchain networks to provide its cross-ledger transfer services for a fixed known commission in each direction. Thus, confirming that facilitator's account 1514 contains at least XXX units of the crypto token, the node initiates the cross-chain transaction with initiation of intra-ledger transaction 1515, which transfers (XXX units+Y units commission for the facilitator entity) from sender's account to the escrow account 1513.

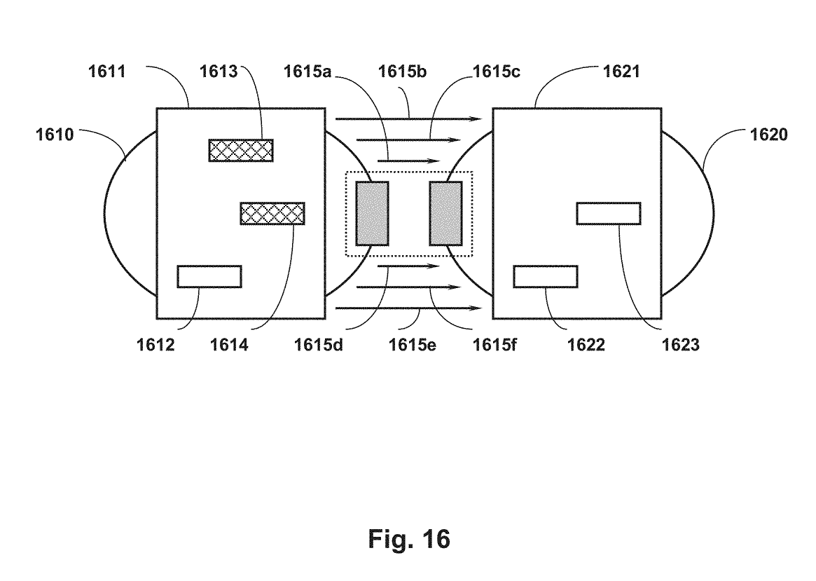

FIG. 16 is block diagram of ledgers of two interconnected blockchain networks and step Two of a cross-chain transaction transferring tokens from any account to any account. This step was described in depth with FIG. 11, FIG. 12, FIG. 13, and with the description of cross-chain transfer of units of tokens between the accounts of the facilitator entity in the ledgers of both interconnected blockchain networks. On FIG. 16 the meta-accounts of the facilitator entity are not presented for simplicity. For the same reason, the intra-ledger transactions implementing the actual transfer of tokens from the account of the facilitator entity in the sender's ledger to the account of the facilitator entity in the recipient's ledger are also not presented.

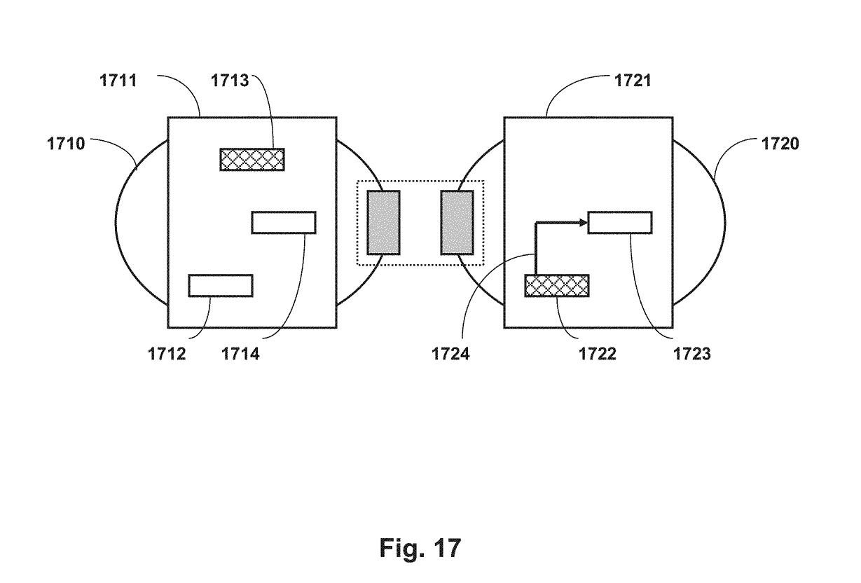

FIG. 17 is block diagram of ledgers of two interconnected blockchain networks and step Three of a cross-chain transaction transferring tokens from any account to any account. The facilitator node on the recipient blockchain network 1720, after receiving notification messages from F+1 nodes of the sending blockchain network 1710 requesting transfer of XXX units of a crypto token from account 1722 in ledger 1721 to the recipient account 1723 in ledger 1721 and after executing an intra-chain transaction that transferred XXX units of a crypto token to account 1722, calls the agent of the facilitator. The agent initiates execution of intra-chain transaction 1724, which transfers the XXX units of a crypto token from the facilitator's account 1722 in ledger 1721 to the recipient account 1723 in ledger 1721.

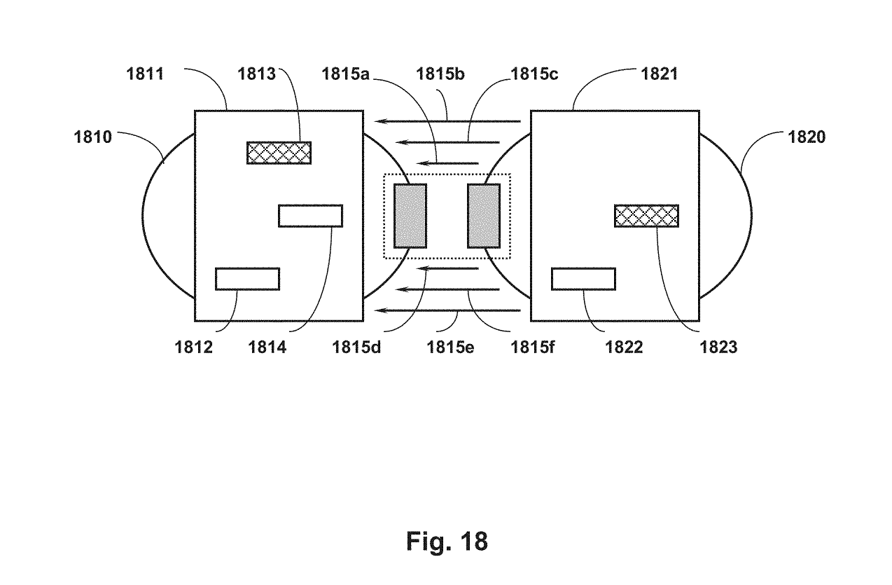

FIG. 18 is block diagram of ledgers of two interconnected blockchain networks and step Four of a cross-chain transaction transferring tokens from any account to any account. Every node of blockchain network 1820, having transferred XXX units of a crypto token to the recipient account 1823 in ledger 1821, multicasts a notification message, presented on the diagram as 1815a, 1815b, 1815c, 1815d, 1815e, and 1815f, containing a signed receipt to every node of sender's blockchain network 1810.

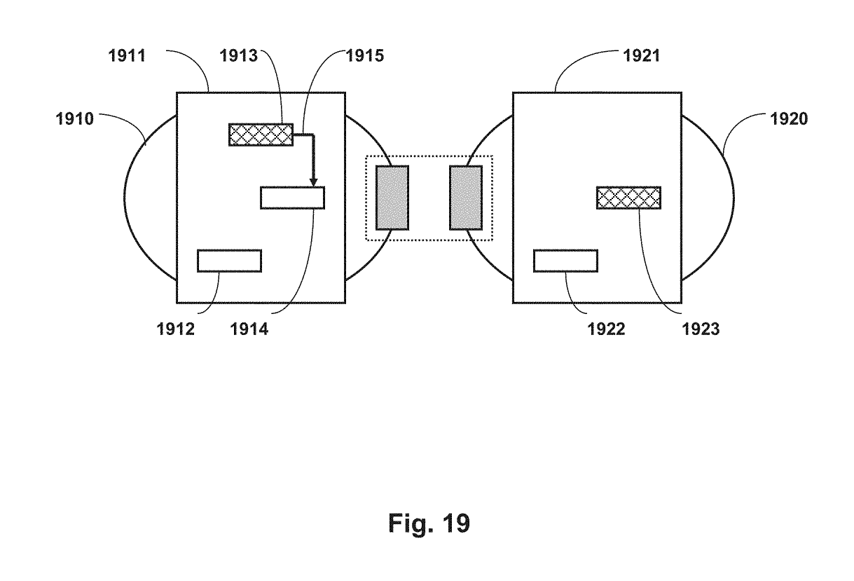

FIG. 19 is block diagram of ledgers of two interconnected blockchain networks and step Five of a cross-chain transaction transferring tokens from any account to any account. The facilitator node on blockchain network 1910, on receiving notification messages from F+1 nodes of the blockchain network 1920 verifies the signatures confirming the transfer of XXX units of a crypto token to the recipient account 1923 and on having F+1 correct confirmations calls the agent of the facilitator. The agent initiates execution of intra-chain transaction 1915, which if approved by F+1 nodes of network 1910, according to the escrow contract conditions will complete the contract with transfer of (XXX+Y) units of a crypto token from the escrow account 1913 to facilitator's account 1914. Each honest node of blockchain network 1910, which has received notification messages from F+1 nodes of the blockchain network 1920 and has verified the signatures confirming the transfer of XXX units of a crypto token to recipient the account 1923, approves the initiated execution of intra-chain transaction 1915, and sends a payment confirmation with at least F+1 payment receipts to the sender account owner. Having been approved by F+1 nodes of blockchain network 1910, transaction 1915 becomes executed and committed, and the facilitator entity becomes reimbursed for the XXX transmitted units of a crypto token and receives the commission of Y units for its services.

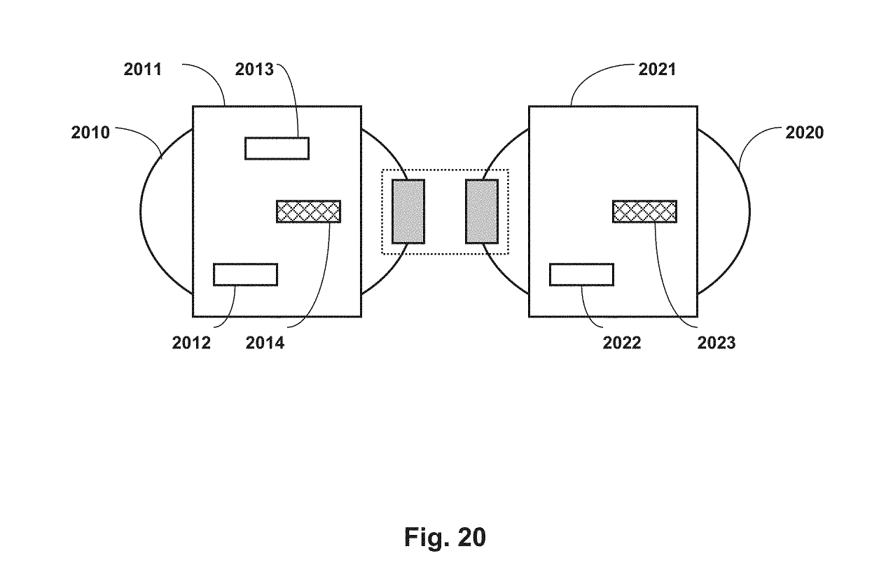

FIG. 20 is block diagram of ledgers of two interconnected blockchain networks and final state of a cross-chain transaction transferring tokens from any account to any account. The recipient account 2023 in the ledger 2021 of blockchain network 2020 has received XXX units of a crypto token. The sender account 2012 has sent XXX units of a crypto token+Y units commission for the cross-chain transfer and received payment confirmations from at least F+1 nodes of network 2010, each confirmation containing signed receipts from at least F+1 nodes of network 2020. Facilitator entity's account 2014 in the ledger 2011 of blockchain network 2010 was reimbursed for the transferred XXX units of a crypto token and received Y units commission for the cross-chain transfer.

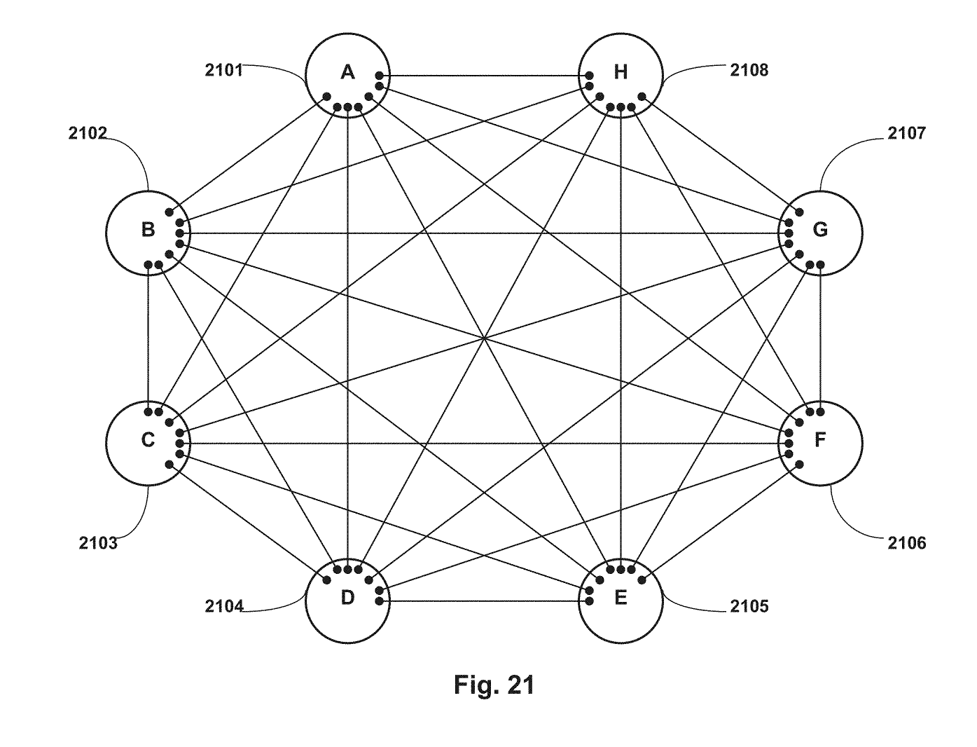

FIG. 21 is block diagram of a federation of eight interconnected blockchain networks, where every network is directly interconnected to every other network. On the block diagram, blockchain networks 2101, 2102, 2103, 2104, 2105, 2106, 2107, and 2108 are directly interconnected to each other. Direct interconnection between two blockchain networks means that every node of each of both networks has an established connection to every node of the other network. For clarity of the block diagram, the only presented network nodes are those belonging to the facilitator entity for each pair of networks, and the only presented connections are those between the nodes belonging to the facilitator entity for each pair of networks.

If only two networks were interconnected for cross-chain transactions that involve a common token, each network knows the aggregated amount of token units held in its own accounts and the aggregated amount of token units in the other network. After a cross-chain transfer of token units between the accounts of the facilitator, both networks update the amounts held in each one. Each node of the facilitator entity in a network serves as ambassador representing the interests of the other network. For example, if the majority of a network colludes to fraudulently increase the amount of token units held in its ledger accounts, the ambassador node should send a notification to the other network with an evidence and decline supporting cross-chain transactions until the fraudulently created token units are destroyed.

Where more than two networks are interconnected, as presented on FIG. 21, the nodes of each network maintain in meta-accounts the aggregate amount of units of the common token held in each network. After a cross-chain transfer of tokens between any two networks, each node of these two networks that is an ambassador node of a third party network sends a notification to the network it represents. These notification messages perform dual function. Firstly, each network that does not participate in the transfer becomes a notary witnessing the transfer. Secondly, it lets record the transfer and update content of the meta-accounts representing the aggregate amount of units of the common token held in each network. Existence of multiple ambassador nodes minimizes the chances that a colluding majority may be formed and excludes the possibility that a fraudulent creation of tokens may happen undetected.

Such a federation is more efficient, compared to a single blockchain network, if cross-chain transactions are a small proportion of the total and with regional rather than a global integration of networks because of the faster exchange of consensus messages. Following the same approach, a cross-regional integration or a plurality of cross-regional integrations may be established.

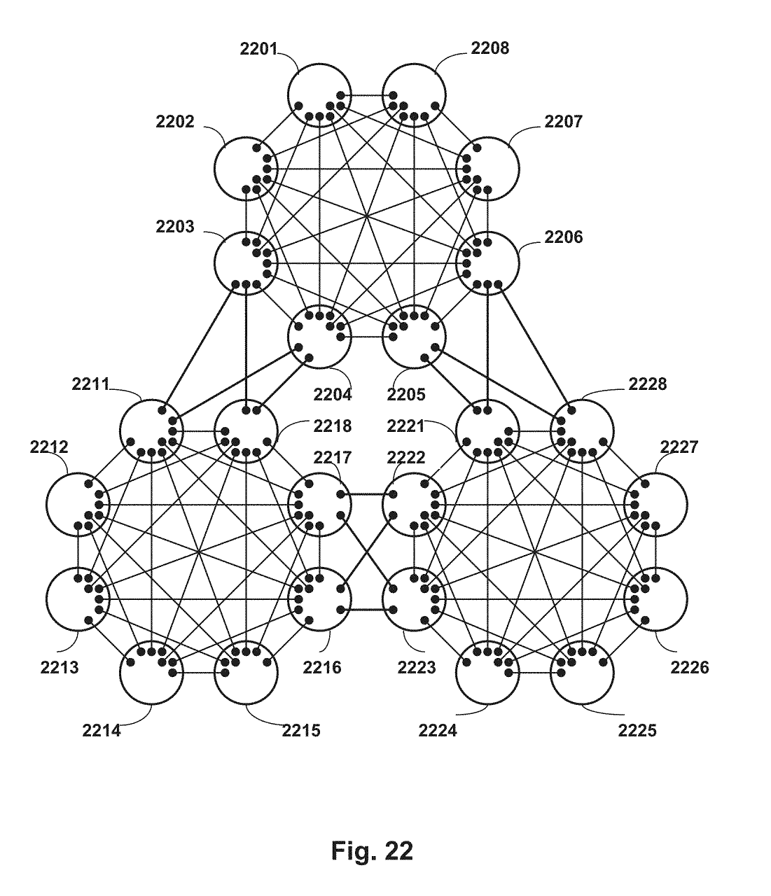

FIG. 22 is block diagram of three connected for interoperability federations, each comprising eight interconnected blockchain networks. On the block diagram, blockchain networks 2201, 2202, 2203, 2204, 2205, 2206, 2207, and 2208 are directly interconnected to each other and form one of the federations. Blockchain networks 2211, 2212, 2213, 2214, 2215, 2216, 2217, and 2218 are directly interconnected to each other and form the other federation. Blockchain networks 2221, 2222, 2223, 2224, 2225, 2226, 2227, and 2228 are directly interconnected to each other and form the third federation. For clarity of the block diagram, the only presented network nodes are those belonging to the facilitator entity for each pair of networks, and the only presented connections are those between the nodes belonging to the facilitator entity for each pair of networks.

Integration between two regional federations requires two networks of a federation to interconnect with two networks of another federation. With this objective, each of blockchain networks 2203 and 2204 is directly interconnected to each of blockchain networks 2211 and 2218, each of blockchain networks 2216 and 2217 is directly interconnected to each of blockchain networks 2222 and 2223, and each of blockchain networks 2221 and 2218 is directly interconnected to each of blockchain networks 2205 and 2206. A cross-federation transfer of units of a token is implemented as transfer across a pair of interconnected networks, each belonging to a different federation, and witnessed by the second pair of interconnected networks. For example, a cross-federation transfer from network 2211 to network 2203 is witnessed by networks 2218 and 2204. The outcome is propagated in each federation by the ambassador nodes in the network participating in the transfer and in the witnessing network. As a result, each node in networks of a federation knows the exact aggregate balance of token units in each federation.

Where the three federations use a common token, the outcome of a cross-federation transfer has to be propagated inside the non-participating federation as well. Thus, the non-participating federation acts as well as a witness of the cross-federation transfer. With this objective, the ambassador nodes representing networks of the non-participating federation in networks of the participating federations send notification messages. In the example of a cross-federation transfer from network 2211 to network 2203, two ambassador nodes from networks 2216 will send notifications to network 2222 and network 2223, two ambassador nodes from networks 2217 will send notifications to network 2222 and network 2223, two ambassador nodes from networks 2205 will send notifications to network 2221 and network 2228, and two ambassador nodes from networks 2206 will send notifications to network 2221 and network 2228.

Where a transfer of units of a token is from a blockchain network of one federation to a blockchain network of another federation, in the majority of cases these networks are not interconnected. This does not mean inability to execute the transfer with the safety of a cross-chain transaction. Interoperability between two federations requires that any network of a federation can transact with any network of the other federation. In such case, the cross-chain transfer goes across a sequence of at least three interconnected blockchain networks, and typically, but not necessarily, across a sequence of no more than four interconnected network. We call such cross-chain transaction an indirect one. An indirect cross-chain transaction concatenates at least two cross-chain transfers—one from sender's blockchain network to the third party blockchain network and one from the third party blockchain network to the recipient's blockchain network.

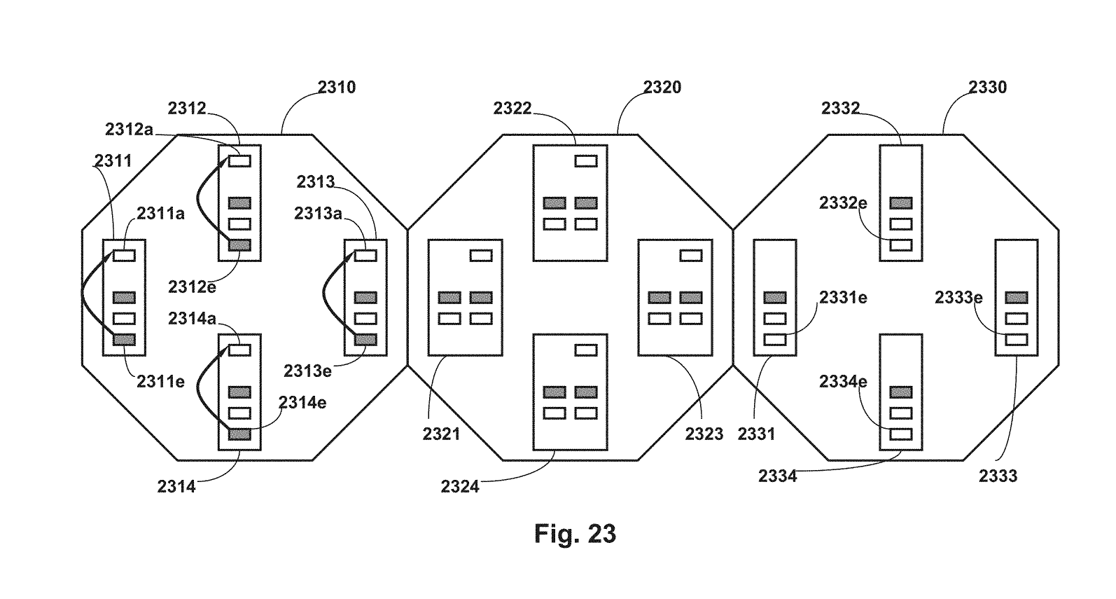

FIG. 23 is block diagram of sub-transaction One of the simplest indirect cross-chain transaction. It transfers units of a token across a sequence of three interconnected blockchain networks. On the diagram, blockchain network 2310 is interconnected to blockchain network 2320, and blockchain network 2320 is interconnected to blockchain network 2330. Interconnection of two blockchain networks means that every node of one of the networks has an established connection to every node of the other network. Blockchain networks 2310 and 2330 are not interconnected. They are indirectly connected via blockchain network 2320. On the diagram, each network consists of four nodes, but the nodes are not presented for clarity. Presented are the individual ledgers, each maintained on a node. Network 2310 maintains ledgers 2311, 2312, 2313, and 2314. Network 2320 maintains ledgers 2321, 2322, 2323, and 2324. Network 2330 maintains ledgers 2331, 2332, 2333, and 2334.

Objective of the cross-chain transaction is to transfer XXX units of a token from an account presented on the ledgers maintained on network 2310 as accounts 2311e, 2312e, 2313e, and 2314e to an account presented on the ledgers maintained on network 2330 as accounts 2331e, 2332e, 2333e, and 2334e. Execution of this transaction requires cross-chain transfer of token units from network 2310 to network 2320 and from network 2320 to network 2330. The business entity facilitating the transfer from network 2310 to network 2320 requires a fee of Y units of the token for its service. The business entity facilitating the transfer from network 2320 to network 2330 requires a fee of Z units of the token for its service.

The transfer of XXX token units requires the sender's account to contain at least XXX+Y+Z token units, the account on network 2310 of the entity that facilitates the transfer of token units between networks 2310 to network 2320 must contain at least) XXX+Z token units, and the account on network 2320 of the entity that facilitates the transfer of token units between networks 2320 to network 2330 must contain at least XXX token units. For clarity of the block diagrams describing the intra-chain transactions that are sub-transactions of the cross-chain transaction, each one of these three accounts contains the exact minimum amount of token units that lets the cross-chain transaction be executed successfully. For the same reason, the escrow account on network 2310, the escrow account on network 2320, and the recipient account on network 2330, each contains zero token units.

The cross-chain transaction starts with an intra-chain transaction transferring XXX+Y+Z units of the token from the sender's account presented on the ledgers maintained on network 2310 as accounts 2311e, 2312e, 2313e, and 2314e to an escrow account presented on the same ledgers as accounts 2311a, 2312a, 2313a, and 2314a. Once the XXX+Y+Z units of the token are in the escrow account, they are under control of a escrow contract that will complete with one of the two possible outcomes: On receiving signed receipts from F+1 nodes of the recipient's network confirming a successful delivery to the recipient account, the contract will transfer the XXX+Y+Z units on escrow to the account of the entity facilitating transfer of XXX+Z units from network 2310 to network 2320; On timeout event before receiving signed receipts, the contract will transfer the XXX+Y+Z units on escrow back to the sender's account.

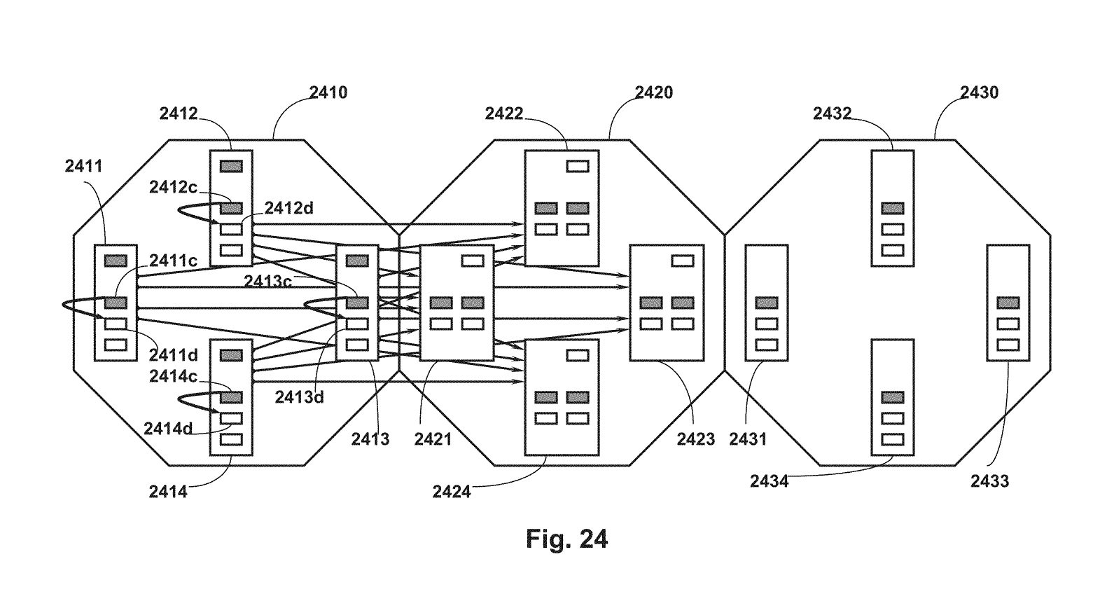

FIG. 24 is block diagram of sub-transaction Two of the simplest indirect cross-chain transaction. The software agent of the entity, which facilitates transfer from network 2410 to network 2420, runs on the node that belongs to that entity and maintains ledger 2413 on network 2410. The agent is programmed to make a decision to participate in any cross-chain transaction that satisfies its predetermined condition for participation. Once the running it node informs it that the escrow contract will pay the predetermined Y token units fee if the entity facilitates a transfer of XXX+Z token units to network 2420 as part of the transfer of XXX token units to the final recipient account in network 2430, the agent decides to participate. It initiates an intra-chain transaction that is part of the transfer from network 2410 to 2420. This intra-chain transaction transfers XXX+Z units from the facilitating entity's account presented on the ledgers maintained on network 2410 as accounts 2411c, 2412c, 2413c, and 2414c to the meta-account representing the facilitating entity's account in network 2420, presented on the ledgers maintained on network 2410 as accounts 2411d, 2412d, 2413d, and 2414d. On completion of this intra-chain transaction, every node of network 2410 sends a notification message to every node of network 2420.

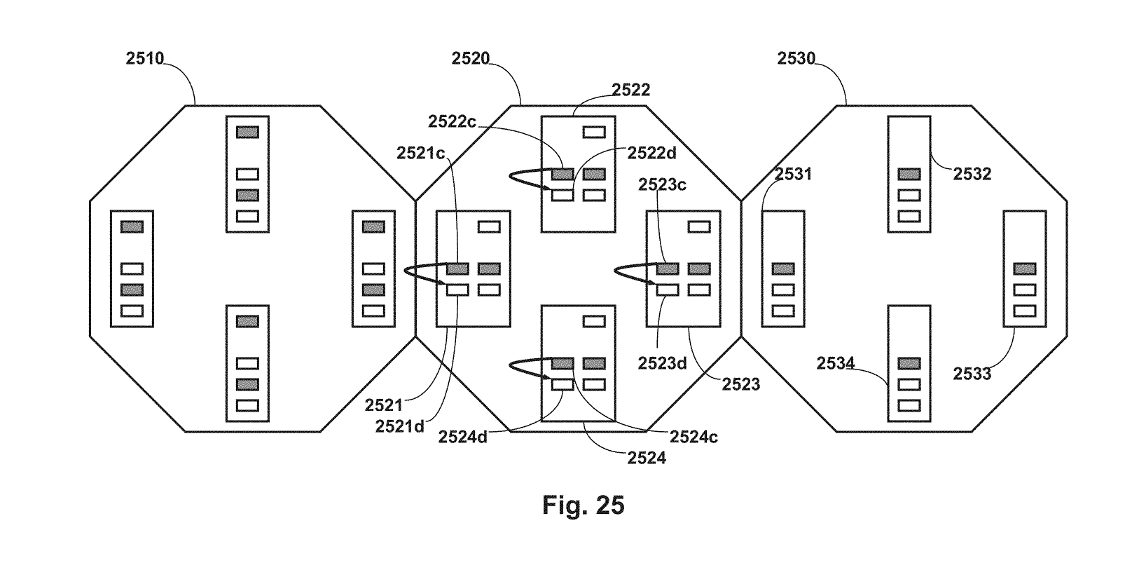

FIG. 25 is block diagram of sub-transaction Three of the simplest indirect cross-chain transaction. On receiving notification messages from F+1 nodes of network 2510, the node of network 2520 that belong to the entity that facilitates transfer from network 2510 to network 2520 informs the running on it software agent of that entity about the content of that notification. The agent initiates an intra-chain transaction that replicates the intra-chain transaction executed on network 2510. This intra-chain transaction transfers XXX+Z units from the meta-account representing the facilitating entity's account in network 2510, presented on the ledgers maintained on network 2520 as accounts 2521c, 2522c, 2523c, and 2524c to the facilitating entity's account in network 2520 presented on the ledgers maintained on network 2520 as accounts 2521d, 2522d, 2523d, and 2524d. On completion of this intra-chain transaction, the transferred XXX+Z units are under the control of the software agent on network 2520 of the entity that facilitates the transfer from network 2510 to network 2520.

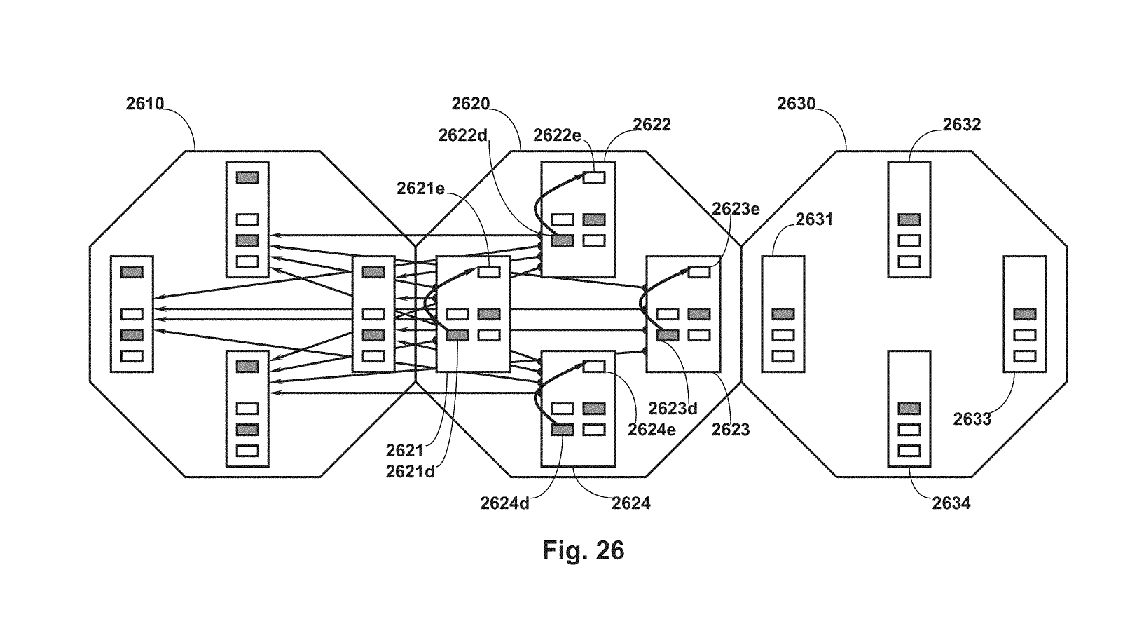

FIG. 26 is block diagram of sub-transaction Four of the simplest indirect cross-chain transaction. The software agent on network 2620 of the entity that facilitates the transfer from network 2610 to network 2620 knows that the entity will receive the fee of Y units waiting on network 2610 only on condition of timely received signed receipts from F+1 nodes of network 2630 about XXX units delivered to the recipient account in the ledgers maintained on network 2630. The agent initiates an intra-chain transaction that transfers the XXX+Z units from the facilitating entity's account in network 2620 presented on the ledgers maintained on network 2620 as accounts 2621d, 2622d, 2623d, and 2624d to an escrow account presented on the ledgers maintained on network 2620 as accounts 2621e, 2622e, 2623e, and 2624e. Once the XXX+Z units of the token are in the escrow account, they are under control of an escrow contract that will complete with one of the with two possible outcomes: Or receiving signed receipts from F+1 nodes of the recipient's network confirming a successful delivery to the recipient account, the contract will transfer the XXX+Z units on escrow to the account of the entity facilitating transfer of XXX+Z units from network 2620 to 2630; On timeout event before receiving signed receipts, the contract will transfer the XXX+Z units on escrow back to the facilitating entity's account in network 2620 presented on the ledgers maintained on network 2620 as accounts 2621d, 2622d, 2623d, and 2624d. On completion of this intra-chain transaction, every node of network 2620 sends a notification message to every node of network 2610 to update the content of the meta-account on ledgers of network 2610 representing the content of the account presented on the ledgers maintained on network 2620 as accounts 2621d, 2622d, 2623d, and 2624d. These messages trigger on network 2610 execution of an intra-chain transaction that updates the content of that meta-account.

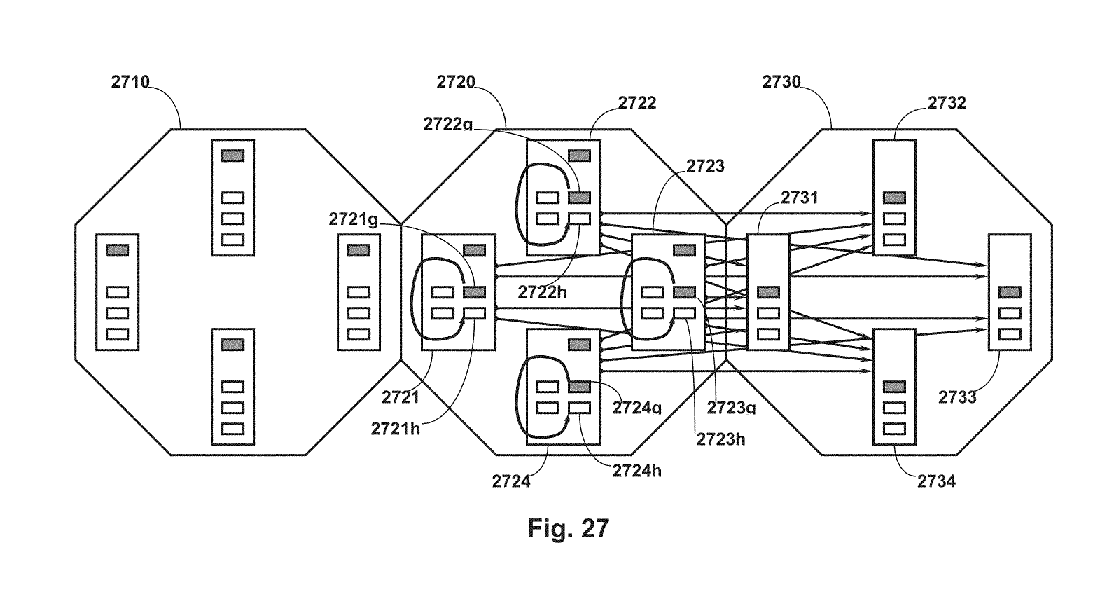

FIG. 27 is block diagram of sub-transaction Five of the simplest indirect cross-chain transaction. The software agent of the entity, which facilitates transfer from network 2720 to network 2730, runs on the node that belongs to that entity and maintains ledger 2723 on network 2720. The agent is programmed to make a decision to participate in any cross-chain that satisfies its predetermined condition for participation. Once the running it node informs it that the escrow contract will pay the predetermined Z token units fee if the entity facilitates a transfer of XXX token units to network 2730 as part of the transfer of XXX token units to the final recipient account in network 2730, the agent decides to participate. It initiates an intra-chain transaction that is part of the transfer from network 2720 to 2730. This intra-chain transaction transfers XXX units from the facilitating entity's account presented on the ledgers maintained on network 2720 as accounts 2721g, 2722g, 2723g, and 2724g to the meta-account representing the facilitating entity's account in network 2730, presented on the ledgers maintained on network 2720 as accounts 2721h, 2722h, 2723h, and 2724h. On completion of this intra-chain transaction, every node of network 2720 sends a notification message to every node of network 2730.

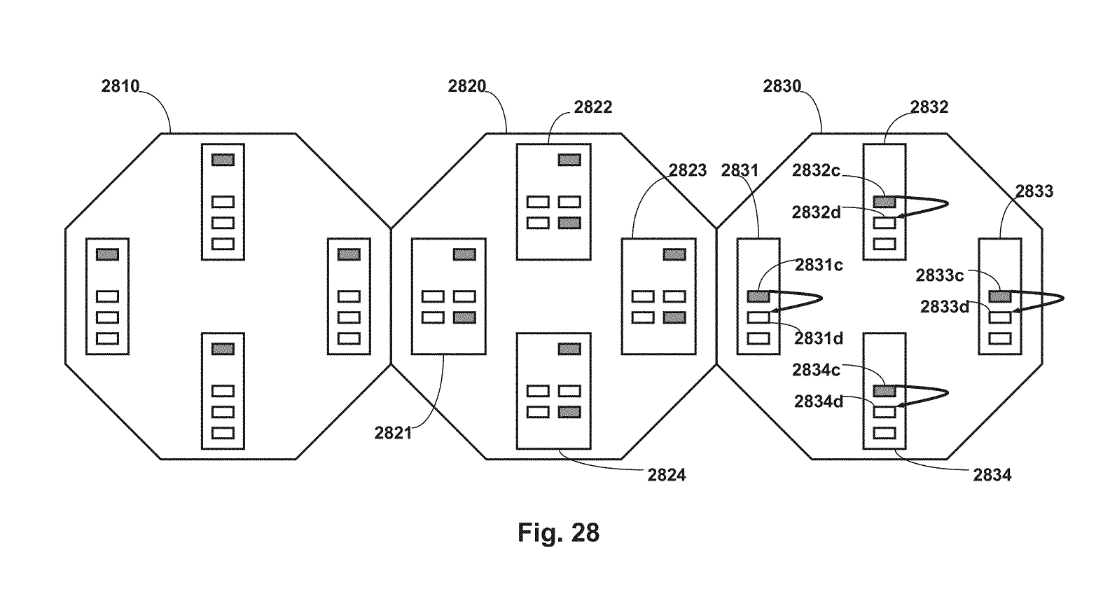

FIG. 28 is block diagram of sub-transaction Six of the simplest indirect cross-chain transaction. On receiving notification messages from F+1 nodes of network 2820, the node of network 2830 that belong to the entity that facilitates transfer from network 2820 to network 2830 informs the running on it software agent of that entity about the content of that notification. The agent initiates an intra-chain transaction that replicates the intra-chain transaction executed on network 2820. This intra-chain transaction transfers XXX units from the meta-account representing the facilitating entity's account in network 2820, presented on the ledgers maintained on network 2830 as accounts 2831c, 2832c, 2833c, and 2834c to the facilitating entity's account in network 2830 presented on the ledgers maintained on network 2830 as accounts 2831d, 2832d, 2833d, and 2834d. On completion of this intra-chain transaction, the transferred XXX units are under the control of the software agent on network 2830 of the entity that facilitates the transfer from network 2820 to network 2830.

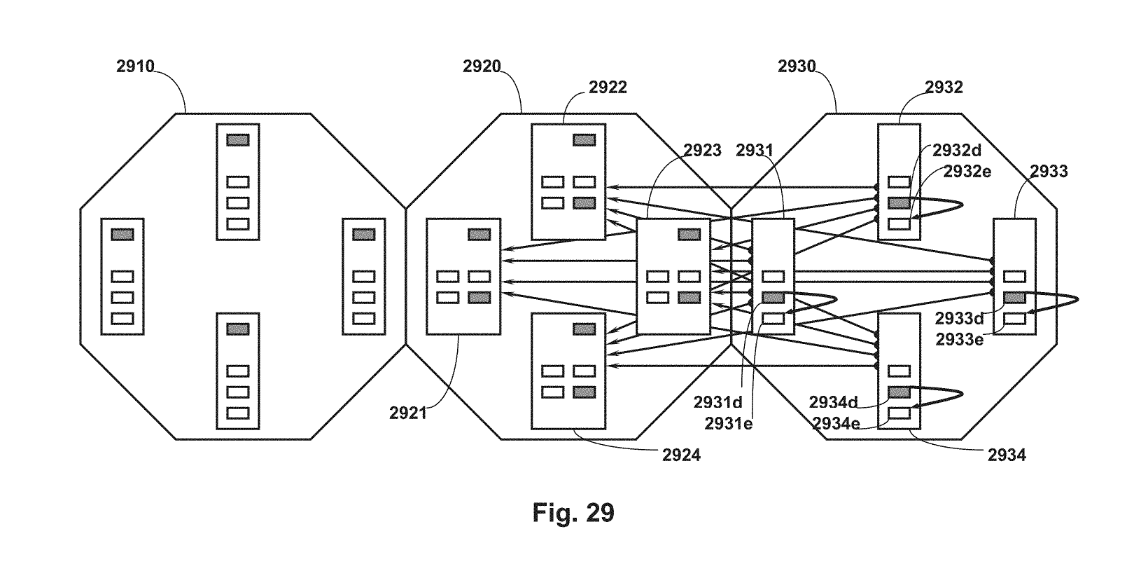

FIG. 29 is block diagram of sub-transaction Seven of the simplest indirect cross-chain transaction. The software agent on network 2930 of the entity that facilitates the transfer from network 2920 to network 2930 knows that the entity will receive the fee of Z units waiting on network 2920 only on condition of timely received signed receipts from F+1 nodes of network 2930 about XXX units delivered to the recipient account in the ledgers maintained on network 2930. The agent initiates an intra-chain transaction that transfers the XXX units from the facilitating entity's account in network 2930 presented on the ledgers maintained on network 2930 as accounts 2931d, 2932d, 2933d, and 2934d to the recipient account presented on the ledgers maintained on network 2930 as accounts 2931e, 2932e, 2933e, and 2934e. On completion of this intra-chain transaction, every node of network 2930 sends a notification message to every node of network 2920 to update the content of the meta-account on ledgers of network 2920 representing the content of the account presented on the ledgers maintained on network 2930 as accounts 2931d, 2932d, 2933d, and 2934d. These messages trigger on network 2920 execution of an intra-chain transaction that updates the content of that meta-account. Every message sent by a node of network 2930 to every node of network 2920 contains a signed by the sending node receipts confirming the delivery of XXX token units to the recipient account of that node.

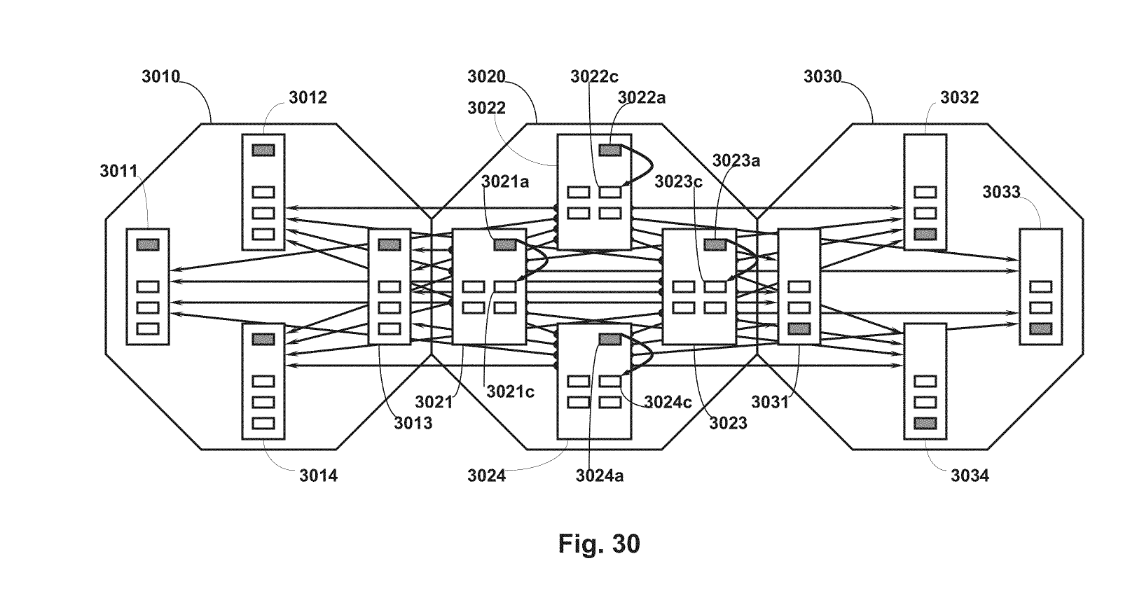

FIG. 30 is block diagram of sub-transaction Eight of the simplest indirect cross-chain transaction. On receiving notification messages from F+1 nodes of network 3030, the node of network 3020 that belongs to the entity that facilitates transfer between network 3030 and network 3020 informs the running on it software agent of that entity about the content of that notification. The agent passes the signed receipts from F+1 nodes of network 3030 to the running on the same node escrow contract. Having confirmed the delivery of the XXX token units to the recipient account, the contract initiates its completion with payment of escrowed XXX+Z token units to the facilitator's entity account. The initiated intra-chain transaction needs approvals of escrow contracts running on F+1 nodes of network 3020. An escrow contract on a node will approve this transaction if the node has received and passed to it the signed receipts from F+1 nodes of network 3030. On approval by escrow contracts running on F+1 nodes of network 3020, the intra-chain transaction transfers XXX+Z token units from the escrow account presented on the ledgers of nodes of network 3020 as 3021a, 3022a, 3023a, and 3024a to entity's account presented on the ledgers of nodes of network 3020 as 3021c, 3022c, 3023c, and 3024c. On completion of this intra-chain transaction, every node of network 3020 sends a notification message to every node on network 3030 to update the content of the meta-account that represents the content of the account presented on the ledgers of nodes of network 3020 as 3021c, 3022c, 3023c, and 3024c, and a notification message to every node on network 3010 containing a signed receipt confirming that it has verified the signed receipts of at least F+1 nodes of network 3030.

Every node of a member network of a federation knows the public key of every node of a member network of that federation. Moreover, since two networks of a federation are interconnected with two networks of another federation for interoperability, every node of each pair of networks know the public key of every node of the other pair of networks. As the networks 3010 and 3030 are not directly interconnected and both are members of different federations, the nodes of network 3010 do not know the public keys of the nodes of network 3030 and cannot verify their signatures. However, regardless in which federation the network 3020 is member, its nodes know the public keys of the nodes of network 3030, and the nodes of network 3010 know the public keys of the nodes of network 3020.

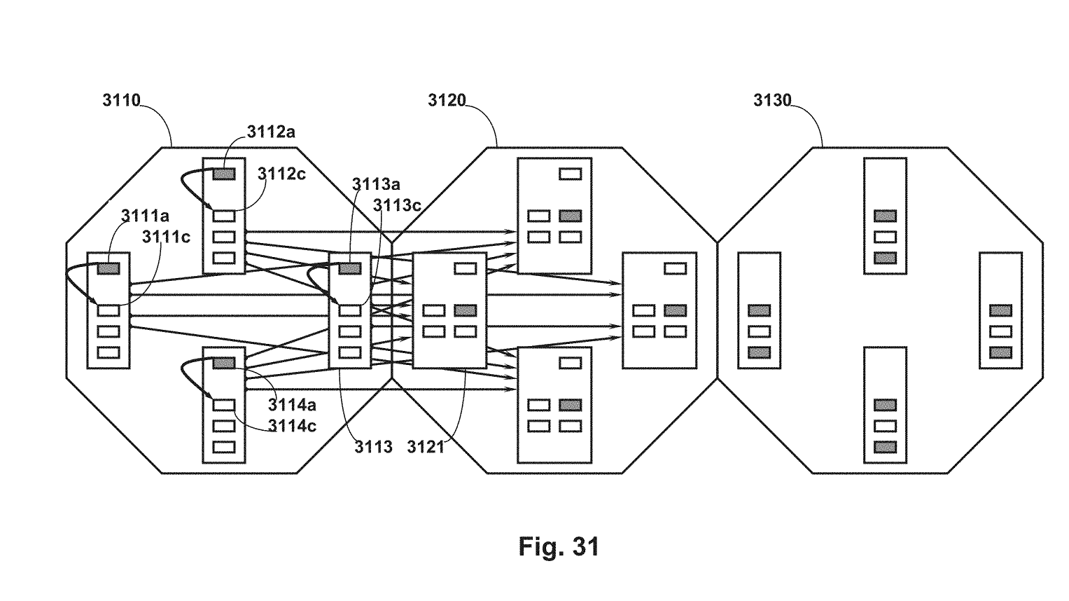

FIG. 31 is block diagram of sub-transaction Nine of the simplest indirect cross-chain transaction. On receiving notification messages from F+1 nodes of network 3120, the node of network 3110 that belongs to the entity that facilitates transfer between network 3110 and network 3120 informs the running on it software agent of that entity about the content of that notification. The agent passes the signed receipts from F+1 nodes of network 3120 to the running on the same node escrow contract. Having confirmed the delivery of the XXX token units to the recipient account, the contract initiates its completion with payment of escrowed XXX+Y+Z token units to the facilitator's entity account. The initiated intra-chain transaction needs approvals of escrow contracts running on F+1 nodes of network 3110. An escrow contract on a node will approve this transaction if the node has received and passed to it the signed receipts from F+1 nodes of network 3120. On approval by escrow contracts running on F+1 nodes of network 3110, the intra-chain transaction transfers XXX+Y+Z token units from the escrow account presented on the ledgers of nodes of network 3110 as 3111a, 3112a, 3113a, and 3114a to entity's account presented on the ledgers of nodes of network 3110 as 3111c, 3112c, 3113c, and 3114c. On completion of this intra-chain transaction, every node of network 3110 sends a notification message to every node on network 3120 to update the content of the meta-account that represents the content of the account presented on the ledgers of nodes of network 3110 as 3111c, 3112c, 3113c, and 3114c.

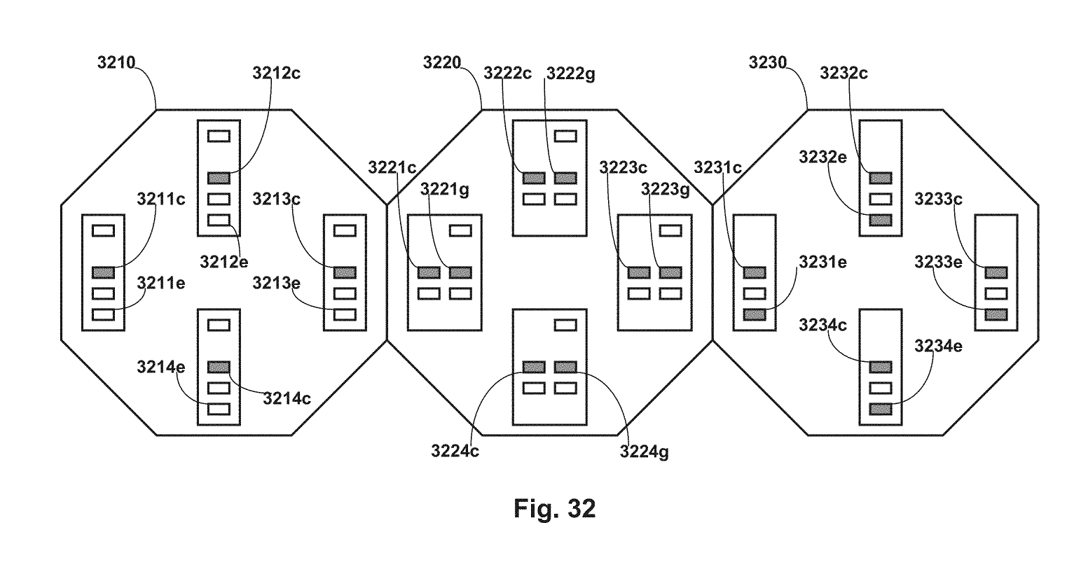

FIG. 32 is block diagram of the final state of the simplest indirect cross-chain transaction. After completion of the transaction, the content of all involved accounts and meta-account is as follows (on assumption that they did not participate in an overlapping transaction). The recipient account presented on the ledgers maintained by network 3230 as accounts 3231e, 3232e, 3233e, and 3234e contains XXX token units. The account on network 3220 of the business entity facilitating transfer of token units between networks 3220 and 3230, presented on the ledgers maintained by network 3220 as accounts 3221g, 3222g, 3223g, and 3224g, as well as the meta-account that represents its content on network 3230, presented on the ledgers maintained by network 3230 as accounts 3231c, 3232c, 3233c, and 3234c, both contain XXX+Z token units. The account on network 3210 of the business entity facilitating transfer of token units between networks 3210 and 3220, presented on the ledgers maintained by network 3210 as accounts 3211c, 3212c, 3213c, and 3214c, as well as the meta-account that represents its content on network 3220, presented on the ledgers maintained by network 3220 as accounts 3221c, 3222c, 3223c, and 3224c, both contain XXX+Y+Z token units. The sender's account, presented on the ledgers maintained by network 3210 as accounts 3211e, 3212e, 3213e, and 3214e, contains zero token units.

To be able to freely transact between themselves, the networks of a federation need a common token to be used with the transactions within the federation. Eventually, the common token of a federation may become the common token of an interoperable plurality of federations. The units of such token are asset by themselves as they are the transport vehicle for movement of value across the networks with cross-chain transactions. In contrast, the transactions within a blockchain network may involve tokens representing financial or physical assets, or tokens that are proxies of fiat money or proxies of crypto coins operating on open networks. Typically, these tokens cannot be transferred beyond the boundaries of a blockchain network as these tokens are liabilities of the network. It must provide legal guarantees that with the purchase of tokens representing financial or physical assets the new owner of a unit of such token legally becomes an owner of a unit of the represented financial or physical asset, and mechanisms to automatically transform the ownership of a crypto coin proxy token into ownership of a crypto coin in the open blockchain network. Similarly, the seller of a token unit representing a unit of a financial or physical assets, or a crypto coin proxy token, becoming the owner of a unit of fiat proxy token legally becomes the owner of the unit of a fiat currency in a bank account represented by this unit of a fiat proxy token. Thus, with an implementation of a trading engine, a blockchain network most naturally becomes a decentralized exchange with real time settlement for these four categories of tokens: the common token of the federation, the tokens representing financial or physical assets, crypto coin proxy tokens, and the fiat proxy tokens.

The traders on a decentralized exchange implemented on a blockchain network need automated conversion of units of a fiat proxy token into fiat money in the trader's bank account and vice versa. A permissioned blockchain network establishes automatic interoperability with a plurality of banks with the following steps: 1) Generates units of a fiat proxy token that become a collective liability of the entities that run the nodes of this blockchain and as a liability are backed with money in bank accounts, each account under the collective control of the blockchain entities as a whole; 2) Implement a facility that lets any user of the blockchain purchase units of the fiat proxy token with fiat money from the user's bank account, but without user's identity on the blockchain being revealed to the bank; 3) Implement a facility that lets any user of the blockchain sell possessed units of the fiat proxy token for fiat money in the user's bank account, but without the real-world identity of the user being revealed to all blockchain nodes, except the node that is required to know the user for compliance with the ‘know your customer’ requirements.

When a node of permissioned blockchain needs liquidity denominated in a fiat proxy token, the needed quantity of units of the fiat proxy token are created by the blockchain network in the following way: a) All node operating entities of a permissioned blockchain open a joint account in a bank; b) The entities specify the quorum needed to operate the joint account; c) The entities specify their electronic identities and the way electronic execution of transactions with this account will be triggered; d) The entity in need of units of the fiat proxy token transfers an amount of fiat money equal to the needed units from its own account to the joint account and receives a digitally signed receipt from the bank; e) On presenting the digitally signed receipt to the blockchain, the blockchain network archives the receipt, creates the equal amount of units of the fiat proxy token, and credits the blockchain account of that entity.

On request from a node holding units of a fiat money token, the blockchain network can terminate the existence of some amount of units of the fiat proxy token in the following way: a) The amount of units of the fiat money token that must cease to exists is placed in an escrow account; b) Blockchain network nodes collectively request from the bank where the joint account exists to transfer the amount of money equal to the amount of units of the fiat money token that must cease to exists to an account appointed by the node holding that units of the fiat proxy token and to provide a digitally signed receipt; c) On receiving a receipt, the blockchain network archives the receipt and destroys the units of the fiat money token held on escrow.

When a user needs to purchase units of a fiat proxy token, the user can purchase these units from the node that knows the real world identity of the user. A user is typically identified on the blockchain with a pseudonym string representing a public key. Purchasing these units by paying with fiat money happens in the following way: 1) The user requests purchasing from the node knowing their real world identity. The nodes of a network perform this service for a known in advance fee; 2) The node places the requested amount of units of a fiat proxy token on escrow on an escrow account controlled by the blockchain network under the following condition: if the user provides within a specified time a digitally signed evidence that they have transferred an amount of fiat money equal to the requested amount of units of a fiat proxy token and the required fee to the node's bank account, the blockchain network will transfer the units of fiat proxy token on escrow in the user's account, otherwise the blockchain network will return the escrowed units back to the node's account; 3) The user executes a known to all nodes hash function taking as input user's identity string, encodes the function output with their private key, and passes the encoded outcome to the bank with a request to transfer from the user account the amount equal to the requested amount of units of the fiat proxy token and the required fee to the node's bank account; 4) The bank executes the requested transfer and provides a digitally signed receipt confirming that the transfer was made by a customer that requested to be identified on the receipt with a particular string; 5) The user passes the digitally signed receipt to any node of the blockchain to claim the units of fiat proxy token on escrow; 6) On receiving the digitally signed receipt, every node of the blockchain uses user's public key to decode the encoded hash function output, and applies the same hash function to user's identity string to verify it is the same as on the receipt; 7) On successful verification, every node takes the units of a fiat proxy token out of the escrow account on its own copy of the ledger and places these tokens to the user account.

A user who owns units of a fiat proxy token on a blockchain may request the blockchain network to convert these units into fiat money in user's bank account without revealing the user's bank account details to every blockchain nodes. Selling units of a fiat proxy token for fiat money happens in the following way: 1) The user applies a hash function to a string containing their real name and bank account details and places the amount of units of the fiat proxy token, for converting and the fee for the node that knows their real world identity, on an escrow account controlled by the blockchain network under the following condition: if the node knowing user's identity transfers to the user's bank account an amount equal to the units of fiat proxy token for conversion and presents a digitally signed receipt from the bank within the specified time, the units of fiat proxy token on escrow will be transferred to node's account, otherwise these tokens will be returned back to user's account; 2) The node requests the bank to transfer the equal amount from node's bank account to user's bank account and to identify this transaction's recipient of fiat money with the output of hash function execution where the input is the user name and user's bank account details; 3) The bank transfers the money and provides a digitally signed receipt where the recipient is identified with the outcome of requested hash function execution; 4) The node passes the digitally signed receipt to the blockchain network nodes to claim the units of fiat proxy token held on escrow; 5) Nodes verify the receipt and the hashed identity of the recipient with hashed identity provided by the user on placing the units of fiat proxy token and the commission units of fiat proxy token on escrow; 6) On successful verification, every node takes the escrowed units out of the escrow account on its own copy of the ledger and places these units to the account of the node that transferred the fiat money to the user's account.

This invention implements a decentralized trading engine that runs on a blockchain network and lets users trade units of one crypto token for units of another one. It operates in the following way. 1) A user who wants to make a trade creates a trade order and submits it to a node; 2) The node instantiates a software agent to handle the order and passes the order parameters to it; 3) The agent tries to match the order against the list containing all orders that were submitted via all nodes of the blockchain network but were not matched. The list of orders is implemented in the following way: A) Copy of this list exists on every node of the blockchain network; B) The token units of an order are placed in an escrow account under the control of the blockchain network via conditions specified in an escrow contract: a) If the specified time for life of the order expires without a trade, the token units are returned to the account that owns the token units; b) If a trade happens before the time expires, the token units are send to the counterparty of the trade; C) A trade happens when the specified order conditions are met; 4) If the order is matched, it becomes a trade; 5) A trade is executed in the following way: A) The agent notifies the escrow contract that the conditions are met; B) The escrow contract takes the order out of the list for a few rounds of the consensus protocol to let the agent transfer the amount of token units according to the escrow contract to the account that owns the token units on escrow; C) The agent initiates a transaction that transfers the amount of token units to the account that owns the token units on escrow; D) The agent initiates a transaction to transfer the amount of token units on escrow; E) Network nodes knowing that the conditions of the escrow contract are met, approve the transaction that will conclude the escrow contract; F) The transaction completion is the settlement of the trade; 6) If the trade order is not matched with an order from the list, according to the instructions from the user, the agent: A) Places the order in the list; B) Specifies the conditions of an escrow contract; C) Initiates a transaction that transfers the token units of the order to the escrow account; D) On transaction completion, the token units become under the control of the network nodes according to conditions of the escrow contract.

This invention provides for interoperability with crypto-coin networks that operate permissionless blockchains. Implementation of such interoperability requires: 1) Existence of a multi-signature account in the crypto-coin network that is controlled with a quorum of F+1 signatures of nodes of the permissioned blockchain network; 2) A seller of crypto-coins from an account in the crypto-coin network who has an account in the permissioned blockchain network and who: A) Wants to exchange crypto-coins from the crypto-coin network for money in a bank account; B) Has an account in a bank that is interoperable with the permissioned blockchain network, or with a permissioned blockchain network of the same federation of interconnected blockchain network, or with a permissioned blockchain network of any federation that is interoperable with the federation of the permissioned blockchain network where the trader has an account; 3) A buyer for the same of crypto-coins in the crypto-coin network who: A) Has an account in that crypto-coin network; B) Has an account in the permissioned blockchain network containing an amount of units of a fiat proxy token representing the fiat money the seller of the crypto-coins wants to convert the coins in.

The steps of conversion of XXX crypto coins in an account on a crypto-coin network to fiat money in a bank account are: 1) The seller notifies the blockchain network running the exchange about the intention to sell XXX coins and provides the account on the crypto-coin network containing at least XXX coins; 2) The network running the exchange generates XXX units of a coin proxy token that become a liability of the network as a whole and places these units in an escrow account under the control of an escrow contract with following conditions: A) On receiving an evidence that XXX coins were sent from the seller's account to the multi-signature account in the crypto-coin network, the escrow contract will send the escrowed XXX units of a coin proxy token to the seller's account in the exchange-running network; B) On timeout, the generated XXX units of a coin proxy token will be destroyed; 3) The seller sends XXX coins to the multi-signature account in the crypto-coin network and provides evidence to the exchange-running network; 4) On receiving the evidence, the escrow contract sends the escrowed XXX units of a coin proxy token to the seller's account in the exchange-running network; 5) The seller trades the XXX units of a coin proxy token for YYY units of a fiat proxy token on the exchange; 6) The seller start a procedure to convert the YYY units of a fiat proxy token for fiat money in account in a bank with established interoperability with the blockchain network, or the seller trades the YYY units of a fiat proxy token for ZZZ units of the federation token on the exchange and sends the received ZZZ units of the federation token to a blockchain network having an established interoperability with the bank where the seller wants the money to be deposited.

The steps of conversion of money in a bank account to XXX crypto coins in an account on a crypto-coin network are: 1) The buyer purchases YYY units of a fiat proxy token paying with fiat money in a bank account; 2) The buyer's software agent trades the YYY units of the fiat proxy token in the buyer's account for XXX units of the coin proxy token and the trade completes with depositing the purchased XXX units of the coin proxy token in the buyer's account; 4) The buyer's software agent places the XXX units of the coin proxy token in an escrow account and starts an escrow contract under the following conditions: A) On receiving evidence that XXX units of the coin token are deposited in the buyer's account on the crypto-coin network, the escrowed XXX units of the coin proxy token will be destroyed; B) On timeout, the escrowed XXX units of the coin proxy token will be returned back to the seller's account; 5) The network running the exchange being aware about the escrow contract starts a software agent to handle the buyer's request; 6) The network's agent obtains the required quorum of network nodes to approve payment from network's multi-signature account on the crypto-coin network; 7) The network's agent instructs the crypto-coin network to send XXX units of the coin token from the multi-signature account on the crypto-coin network to buyer's account on the crypto-coin network; 8) On having an evidence that XXX units of the coin token were deposited in buyer's account on the crypto-coin network, the network's agent passes the evidence to the escrow contract, which destroys the escrowed XXX units of the coin proxy token.

1. A cluster of computers ensuring availability of the essential functionality of a node of a consensus network regardless of a process fault, a computer fault, or a network equipment fault.

2. A cluster of computers as per claim 1, utilizing a method for detection, neutralization, and recovery of a faulty process on a computer.

3. A cluster of computers as per claim 2, further ensuring simultaneous availability and consistency of data modifying operations performed with transactions that access data residing in a single data partition or in a plurality of data partitions of a horizontally scaled data management.

4. A cluster of computers as per claim 3, wherein a transaction manager is preemptively shut down, restarted, and its state resynchronized up to atomic consistency.

5. A cluster of computers as per claim 3, wherein a data management replica is preemptively shut down, restarted, and its state resynchronized up to atomic consistency.

6. A cluster of computers as per claim 3, wherein a plurality of units of binary code is loaded at run time into a transaction manager or a plurality of transaction managers from files for execution under protection of transactions.

7. A consensus network, comprising a plurality of nodes having architecture and running algorithm that defuse the effect of stop faulty processes, and implementing time-bound delivery of messages between a node and a plurality of nodes over the Internet.

8. A consensus network as per claim 7, wherein the network uses synchronous consensus protocol and guarantees time-bound completion of protocol rounds.

9. A consensus network as per claim 8, wherein the consensus algorithm sequentially orders the transaction requests submitted to the network nodes, uses a leaderless Byzantine consensus protocol, and guarantees simultaneous safety and liveness.

10. A consensus network as per claim 9, wherein data modifications on a node are applied with the principles of state machine replication and under protection of local data transactions initiated following the agreed sequential order and executed with a deterministic transaction manager.

11. A federation of blockchain networks comprising a plurality of interconnected networks, wherein per every interconnected pair an entity operates a node in both, and in the ledger of each network it has an account and a meta-account that reflects the content of its account in the other ledger.

12. A federation of blockchain networks as per claim 11, wherein accounts in the ledgers of all networks contain units of a digital token with known number of generated units, wherein an entity with nodes in a pair of interconnected networks has ability to transfer units of the digital token from its account in the ledger of one network to its account in the ledger of the other network.

13. A federation of blockchain networks as per claim 12, wherein a transaction across networks of an interconnected pair facilitates safe transfer of units of a digital token from an account in the ledger of one network of the pair to an account in the ledger of the other network of the pair.

14. A federation of blockchain networks as per claim 13, wherein a transaction across any two networks, indirectly connected via a third party network, concatenates a transfer from sender's network to the third party one and a transfer from the third part one to the recipient's network.

15. A federation of blockchain networks as per claim 14, connected with another federation, or a plurality of federations, wherein an account on a network of a federation performs a transaction with an account on any network of the other federation, or of any federation of the plurality.

16. A federation of blockchain networks as per claim 13, wherein a network generates units of a fiat proxy token that are liability of the network as a whole and are backed by fiat money on escrow in a bank account that is under control of a qualified majority of nodes of the network.

17. A federation of blockchain networks as per claim 16, wherein an owner of an account in the ledger of a network swaps fiat money from a bank account for units of a fiat proxy token or vice versa without revealing a personal identity to all network nodes or a network account identity to the bank.

18. A federation of blockchain networks as per claim 17, wherein a network generates units of tokens that represent ownership of shares in public companies, other securities, or physical assets and account owners trade units of one such token for units of a fiat proxy token or vice versa.

19. A federation of blockchain networks as per claim 17, wherein owners of account on the ledger of a network trade units of federation's common token for units of a fiat proxy token and vice versa.

20. A federation of blockchain networks as per claim 17, wherein a network generates units of a crypto proxy token that are liability of the network as a whole, denominated in a token existing on a cryptocurrency network and backed by units of the token existing on the cryptocurrency network, and an owner of an account in the ledger of the network trades units of the crypto proxy token for units of a fiat proxy token or vice versa.
